(19) United States
(12) Patent Application Publication
(10) Pub. No.: US 2026/0046877 A1
(43) Pub. Date: Feb. 12, 2026

(54) SYSTEM AND DESIGN WITH EFFICIENT RESOURCE ALLOCATION FOR WIRELESS COMMUNICATION NETWORKS

(71) Applicant: Huawei Technologies Co., Ltd., Shenzhen (CN)

(72) Inventors: Kai Xu, Great Falls, VA (US); Weimin Xiao, Hoffman Estates, IL (US); Jialing Liu, Palatine, IL (US); Zhigang Rong, San Diego, CA (US); Hussain Elkotby, Belmont, MA (US)

(21) Appl. No.: 19/301,380

(22) Filed: Aug. 15, 2025

Related U.S. Application Data
(63) Continuation of application No. PCT/US2024/016162, filed on Feb. 16, 2024.
(60) Provisional application No. 63/485,447, filed on Feb. 16, 2023.

(51) Int. Cl. H04W 72/21; H04L 1/1812; H04W 72/115

(52) U.S. Cl. CPC H04W 72/21; H04L 1/1812; H04W 72/115

(57) ABSTRACT

According to embodiments, a method performed by a wireless device includes receiving radio resource control messages comprising configuration parameters indicating a bitfield for uplink control information indication of an unused configured grant (CG) physical uplink shared channel (PUSCH) transmission occasion for a CG with one or more CG PUSCH transmission occasions, wherein: the bitwidth of the bitfield is equal to the quantity of the one or more CG PUSCH transmission occasions; and each bit of the bitfield is associated with a respective CG PUSCH transmission occasion of the one or more CG PUSCH transmission occasions. The method also includes determining a CG PUSCH transmission occasion associated with a bit from the bitfield and determining a status of the CG PUSCH transmission occasion as unused for the bit set to a first value and as a used for the bit being set to a second value.

### PRIORITY CLAIM AND CROSS-REFERENCE

This patent application is a continuation of International Application No. PCT/US2024/016162, filed on Feb. 16, 2024 and entitled “System and Design with Efficient Resource Allocation for Wireless Communication Networks,” which claims priority to U.S. Provisional Application No. 63/485,447, filed on Feb. 16, 2023 and entitled “System and Design with Efficient Resource Allocation for Wireless Communication Networks,” applications of which are hereby incorporated by reference herein as if reproduced in their entireties.

### TECHNICAL FIELD

The present disclosure relates generally to methods, design and apparatus for resource allocation of wireless communication, and, in particular embodiments, to system and design for efficient resource allocation for wireless communication networks with periodic data transmissions.

### BACKGROUND

Extended reality (XR) refers to all real-and-virtual combined environments and human-machine interactions generated by computer technology and wearables. XR is also an umbrella term for different types of realities including Virtual reality (VR), Augmented reality (AR), and Mixed reality (MR). VR is a rendered version of a delivered visual and audio scene. Here, the rendering is designed to mimic the visual and audio sensory stimuli of the real world as naturally as possible to an observer or user as they move within the limits defined by the application. AR is when a user is provided with additional information or artificially generated items, or content overlaid upon their current environment. MR is an advanced form of AR where some virtual elements are inserted into the physical scene with the intent to provide the illusion that these elements are part of the real scene. Each type of reality may have its own traffic pattern/model, which can be applied to both downlink XR traffic and uplink XR traffic. For uplink XR traffic, there are three traffic models defined in 3rd Generation Partnership Project (3GPP), including uplink VR traffic model, uplink cloud gaming traffic model, and uplink AR traffic model. Typically, XR technologies leverage mobile computing by powerful machines and to create experiences for people access through wearables devices (e.g., like goggles or glasses). Today's XR technologies are mainly used for immersive gaming, remote assistance, professional training, and/or the like. However, in the future, XR technologies may also include capsules or rooms people can walk into to experience XR.

Existing XR devices generally use Head-Mounted Displays (HMDs) which have strict constraints on power consumption and weight. HMDs have to be made thin and light to meet the requirements of Quality-of-Experience (QoE) for users. Thus, most computing and storage tasks may be offloaded to a computer or a server to reduce the overall power consumption and weight of HMDs. Most existing XR devices currently use cables to connect HMDs with computers, servers, and/or the like. This significantly limits users' mobility and QoE. Due to limited data rates of Wi-Fi and Bluetooth, they can only support entry-level low-quality XR. 5G-NR and beyond cellular networks and advanced Wi-Fi wireless systems have demonstrated to achieve peak data rates of several Giga bits per second (Gbps). Using these kinds of networks, better wireless connections for XR can be realized. However, recent studies have shown that the ultimate XR requires uncompressed data rates of 2.3 Tera bits per second (Tbps) with a latency lower than 1 ms, which cannot be supported by existing 5G cellular networks and current Wi-Fi technologies.

### SUMMARY

The following example embodiments in this disclosure can be combined or split to generate one or more new embodiments. All the procedures, elements, terms, behaviors, and/or the like described in an embodiment can be applied to (or combined with) one or more other embodiments.

In accordance with an embodiment, a method performed by a wireless device includes receiving, from a network controller, one or more radio resource control messages comprising configuration parameter. The configuration parameters indicate a bitfield for uplink control information indication of an unused configured grant (CG) physical uplink shared channel (PUSCH) transmission occasions for a CG with one or more CG PUSCH transmission occasions, wherein: the bitwidth of the bitfield is equal to the quantity of the one or more CG PUSCH transmission occasions; and each bit of the bitfield is associated with a respective CG PUSCH transmission occasion of the one or more CG PUSCH transmission occasions. The method also includes determining a CG PUSCH transmission occasion, from the one or more CG PUSCH transmission occasions, associated with a bit from the bitfield. The method also includes determining a status of the CG PUSCH transmission occasion as: an unused CG PUSCH transmission occasion in response to the bit being set to a first value; and a used CG PUSCH transmission occasion in response to the bit being set to a second value. The method also includes transmitting a transport block via the used CG PUSCH transmission occasion.

In an embodiment, the bitfield includes two or more bits. In an embodiment, the bitwidth of the bitfield is equal to the total number of bits of the bitfield. In an embodiment, the quantity of the one or more CG PUSCH transmission occasions is equal to the total number of PUSCH transmission occasions of the one or more CG PUSCH transmission occasions. In an embodiment, the association between a bit and CG PUSCH transmission occasion comprises a mapping or link relationship. In an embodiment, the unused CG PUSCH transmission occasion is not used by the wireless device to transmit uplink transport blocks. In an embodiment, the used CG PUSCH transmission occasion is used by the wireless device to transmit uplink transport blocks. In an embodiment, the first value is a one and the second value is a zero. In an embodiment, the first value is a zero and the second value is a one. In an embodiment, the method also includes transmitting the bitfield to the network controller, wherein the bitfield indicates an unused CG PUSCH transmission occasion.

In accordance with an embodiment, a method performed by a base station includes transmitting one or more radio resource control (RRC) messages to a wireless device, wherein the one or more (RRC) messages comprise configuration parameters. The configuration parameters indicate a bitfield for uplink control information indication of an unused configured grant (CG) physical uplink shared channel (PUSCH) transmission occasions for a CG with one or more CG PUSCH transmission occasions, wherein: the bitwidth of the bitfield is equal to the quantity of the one or more CG PUSCH transmission occasions; and each bit of the bitfield is associated with a respective CG PUSCH transmission occasion of the one or more CG PUSCH transmission occasions. The method also includes receiving a transport block via one of the CG PUSCH transmission occasions.

In an embodiment, the bitfield includes two or more bits. In an embodiment, the bitwidth of the bitfield is equal to the total number of bits of the bitfield. In an embodiment, the quantity of the one or more CG PUSCH transmission occasions is equal to the total number of PUSCH transmission occasions of the one or more CG PUSCH transmission occasions. In an embodiment, the association between a bit and a CG PUSCH transmission occasion comprises a mapping or link relationship. In an embodiment, the unused CG PUSCH transmission occasion is not used by the wireless device to transmit uplink transport blocks. In an embodiment, the used CG PUSCH transmission occasion is used by the base station to receive uplink transport blocks from the wireless device. In an embodiment, the first value is a one and the second value is a zero. In an embodiment, the first value is a zero and the second value is a one. In an embodiment, the method also includes receiving a bitfield from the wireless device, wherein the bitfield indicates an unused CG PUSCH transmission occasion. In an embodiment, the method also includes scheduling another device to use the unused CG PUSCH transmission occasion.

In accordance with an embodiment, a method performed by a wireless device includes receiving, from a base station, one or more radio resource control messages comprising configuration parameters. The configuration parameters indicate a configured grant (CG) that comprises a plurality of CG physical uplink shared channel (PUSCH) transmission occasions; a periodicity for the CG; and a quantity of hybrid automatic repeat request (HARQ) processes. The method also includes determining, based on a current symbol, a quantity of the plurality of PUSCH transmission occasions, the periodicity of the CG, and the quantity of HARQ processes, a HARQ identifier for a HARQ process of the CG. The method also includes transmitting, based on the HARQ identifier, and via the plurality of CG PUSCH transmission occasions, an uplink transport block for the CG to the base station.

In an embodiment, the determining the HARQ identifier for the HARQ process of the CG is further based on an offset value for HARQ process. In an embodiment, the determining the HARQ identifier for the HARQ process of the configured grant comprises performing at least one of a division operation, a floor operation, or a modulo operation based on one or more of: the current symbol, the offset value, the nominal periodicity, and the quantity of HARQ processes. In an embodiment, the performing the division operation further comprises performing a subtraction operation and wherein the subtraction operation comprises performing the subtraction operation based on the current symbol and the offset value. In an embodiment, the performing the division operation comprises performing the division operation based on the nominal periodicity. In an embodiment, the performing the division operation further comprises performing the division operation based on a first result of a subtraction operation. In an embodiment, the performing the floor operation comprises performing the floor operation based on a second result of the division operation. In an embodiment, the performing the modulo operation comprises performing the modulo operation based on a third result of the floor operation and the quantity of HARQ processes. In an embodiment, the offset value is a time domain offset value in terms of a quantity of orthogonal frequency-division multiplexing (OFDM) symbols. In an embodiment, the nominal periodicity is a non-integer number of slots. In an embodiment, the nominal periodicity is a nominal periodicity for the CG. In an embodiment, the quantity of HARQ processes is a total number of HARQ processes for the configured grant. In an embodiment, the current symbol is an index of a current orthogonal frequency-division multiplexing (OFDM) symbol in time domain. In an embodiment, wherein the method also includes retransmitting, based on the HARQ process with the HARQ identifier and via the one or more PUSCH transmission occasions, the uplink transport block for the configured grant (CG) to the base station. In an embodiment, the base station is a first network controller. In an embodiment, the nominal periodicity is for extended reality traffic. In an embodiment, the determining the HARQ identifier for the HARQ process of the configured grant comprises performing a subtraction operation, a division operation, a floor operation, and a modulo operation based on one or more of: the current symbol, the offset value, the nominal periodicity, and the quantity of HARQ processes.

In accordance with an embodiment, a method performed by a network controller includes transmitting to a wireless device one or more radio resource control messages comprising configuration parameters. The configuration parameters include a configured grant (CG) comprising a plurality of CG physical uplink shared channel (PUSCH) transmission occasions; a periodicity for the CG; and a quantity of hybrid automatic repeat request (HARQ) processes. The method also includes determining a HARQ identifier for a HARQ process of the CG based on a current symbol, on a quantity of the plurality of PUSCH transmission occasions, on the periodicity for the CG, and on the quantity of HARQ processes. The method also includes receiving, based on the HARQ identifier, and via the plurality of CG PUSCH transmission occasions, an uplink transport block for the CG from the wireless device.

In an embodiment, the determining the HARQ identifier for the HARQ process of the CG is further based on an offset value for HARQ process. In an embodiment, the determining the HARQ identifier for the HARQ process of the configured grant (CG) comprises performing at least one of a division operation, a floor operation, or a modulo operation based on one or more of: the current symbol, the offset value, the nominal periodicity, or the quantity of HARQ processes. In an embodiment, the performing the subtraction operation comprises performing the subtraction operation based on the current symbol and the offset value. In an embodiment, the performing the division operation comprises performing the division operation based on the nominal periodicity. In an embodiment, the performing the division operation further comprises performing the division operation based on a first result of a subtraction operation. In an embodiment, the performing the floor operation comprises performing the floor operation based on a second result of the division operation. In an embodiment, the performing the modulo operation comprises performing the modulo operation based on a third result of the floor operation and the quantity of HARQ processes. In an embodiment, the offset value is a time domain offset value in terms of a quantity of orthogonal frequency-division multiplexing (OFDM) symbols. In an embodiment, the nominal periodicity is a non-integer number of slots. In an embodiment, the nominal periodicity is a nominal periodicity for the CG. In an embodiment, the quantity of HARQ processes is a total number of HARQ processes for the configured grant. In an embodiment, the current symbol is an index of a current orthogonal frequency-division multiplexing (OFDM) symbol in time domain. In an embodiment, the network controller is a first base station. In an embodiment, the nominal periodicity is for extended reality traffic. In an embodiment, the determining the HARQ identifier for the HARQ process of the configured grant (CG) comprises performing a division operation, a floor operation, and a modulo operation based on one or more of: the current symbol, the offset value, the nominal periodicity, or the quantity of HARQ processes. In an embodiment, the configuration parameters further indicate the quantity of the plurality of PUSCH transmission occasions to the wireless device.

In an embodiment, a wireless device may receive, from a base station, one or more radio resource control (RRC) messages. The RRC messages include configuration parameters. The configuration parameters may indicate a subcarrier spacing value. The configuration parameters may indicate a time offset value. The configuration parameters may indicate a nominal periodicity for a configured grant (CG). The nominal periodicity may be equal to a periodicity of extended reality (XR) traffic (arrival). The wireless device determines, based on the nominal periodicity and the time offset value, a first starting time for one or more resources of the configured grant (CG). The wireless device may perform a ceiling operation based on the determined first starting time, where the ceiling operation maps an input to the least integer greater than or equal to the input. The wireless device determines, based on the ceiling operation, a second starting time for the one or more resources of the configured grant (CG). The second starting time is a closest starting point including an integer number of slots for the subcarrier spacing value, where the closest starting point is a minimal value, with an integer number of slots, being equal to or greater than the determined first starting time corresponding to the determined second starting time. The wireless device transmits, to the base station, based on the second starting time, an uplink transport block via the one or more resources of the configured grant (CG). The ceiling operation may be a ceiling function.

In an embodiment, a wireless device may receive, from a base station, one or more radio resource control (RRC) messages. The RRC messages include configuration parameters. The configuration parameters may indicate a time offset value for a configured grant (CG). The configuration parameters may indicate a subcarrier spacing value. The configuration parameters may indicate a first periodicity for the configured grant (CG). The configuration parameters may indicate a second periodicity for the configured grant (CG). The first periodicity may be equal to a minimum periodicity of extended reality (XR) traffic with an integer number of slots for the subcarrier spacing value. The wireless device determines, based on the first periodicity and the time offset value, a first starting time for one or more resources of the configured grant. The wireless device may determine, based on the first starting time and the second periodicity, a second starting time for the one or more resources of the configured grant. The second starting time is located within the first periodicity and occurs with the second periodicity. The wireless device transmits, to the base station, based on the first starting time and the second starting time, one or more uplink transport blocks via the one or more resources of the configured grant.

In an embodiment, a wireless device may receive, from a base station, one or more radio resource control (RRC) messages. The RRC messages include configuration parameters. The configuration parameters may indicate a frame structure including a first downlink slot and a first uplink slot. The configuration parameters may indicate a configured grant (CG). The wireless device may determine, based on a resource allocation scheme, a time domain location for one or more resources of the configured grant. If the time domain location is conflicted with the first downlink slot, the wireless device may shift (or move or adjust) the time domain location, for the one or more resources of the configured grant, to the first uplink slot in response to the time domain location being conflicted with the first downlink slot. The first uplink slot may be the closest uplink slot to the first downlink slot. The first uplink slot may be the closest available uplink slot to the first downlink slot. The first uplink slot may be the first available uplink slot to the first downlink slot. The wireless device transmits, to the base station, based on the first uplink slot, an uplink transport block via the one or more resources of the configured grant (CG). The shifting (or moving or adjusting) the time domain location is performed by the wireless device within a time window. The time window is indicated by the configuration parameters. The resource allocation scheme includes a ceiling operation, a configuration with the first periodicity and the second periodicity, or indications of the configuration parameters. The ceiling operation may be a ceiling function.

In an embodiment, a wireless device may receive, from a base station, one or more radio resource control (RRC) messages. The RRC messages include configuration parameters. The configuration parameters may indicate a configured grant (CG) with one or more CG physical uplink shared channel (PUSCH) transmission occasions. The configuration parameters may indicate a (time) offset value for hybrid automatic repeat request (HARQ). The configuration parameters may indicate a nominal periodicity for an extended reality (XR) traffic (arrival). The configuration parameters may indicate a quantity of HARQ processes for CG. The wireless device determines, based on a current symbol, the (time) offset value, the nominal periodicity, and the quantity of HARQ processes, a HARQ identifier (ID) for the configured grant (CG). A modulo operation and a floor operation are performed by the wireless device based on the current symbol, the (time) offset value, the nominal periodicity, and the quantity of HARQ processes. The wireless device transmits, to the base station, based on the HARQ identifier (ID) and via the one or more CG PUSCH transmission occasions, an uplink transport block for the configured grant (CG). The modulo operation may be a modulo function. The floor operation may be a floor function.

In an embodiment, a wireless device may receive, from a base station, one or more radio resource control (RRC) messages. The RRC messages include configuration parameters. The configuration parameters may indicate a configured grant (CG) with one or more CG physical uplink shared channel (PUSCH) transmission occasions. The configuration parameters may indicate a (time) offset value for hybrid automatic repeat request (HARQ). The configuration parameters may indicate a nominal periodicity for an extended reality (XR) traffic (arrival). The configuration parameters may indicate a quantity of HARQ processes for CG. The base station determines, based on a current symbol, the (time) offset value, the nominal periodicity, and the quantity of HARQ processes, a HARQ identifier (ID) for the configured grant (CG). A modulo operation and a floor operation are performed by the base station based on the current symbol, the (time) offset value, the nominal periodicity, and the quantity of HARQ processes. The base station receives, from the wireless device, based on the HARQ identifier (ID) and via the one or more CG PUSCH transmission occasions, an uplink transport block for the configured grant (CG).

In an embodiment, a wireless device may receive, from a base station, one or more commands. The one or more commands may indicate a configured grant (CG) with a plurality of CG physical uplink shared channel (PUSCH) transmission occasions. The one or more commands may indicate one or more positions of the plurality of CG PUSCH transmission occasions. The one or more positions may include one or more CG PUSCH transmission occasions of the plurality of CG PUSCH transmission occasions. The one or more positions may include one or more frequency domain locations of the plurality of PUSCH transmission occasions. The wireless device may generate a transport block for an extended reality (XR) traffic. The wireless device may determine, based on a size of the transport block, one or more unused CG PUSCH transmission occasions from the plurality of CG PUSCH transmission occasions. The wireless device may transmit, to the base station, via the one or more positions, an uplink control information (UCI) indicating the one or more unused CG PUSCH transmission occasions. The one or more commands include at least one of: one or more radio resource control (RRC) messages; one or more medium access control control elements (MAC CEs); or one or more downlink control information (DCI).

In an embodiment, a wireless device may receive, from a base station, one or more radio resource control (RRC) messages. The RRC messages include configuration parameters. The configuration parameters may indicate a configured grant (CG) with a plurality of CG physical uplink shared channel (PUSCH) transmission occasions. The wireless device may determine, based on a size of a transport block, one or more unused CG PUSCH transmission occasions from the plurality of CG PUSCH transmission occasions. The wireless device may transmit an uplink control information (UCI) including a bitfield indicating the one or more unused CG PUSCH transmission occasions. Each bit of the bitfield may be associated with a respective CG PUSCH transmission occasion of the plurality of CG PUSCH transmission occasions. A bit of the bitfield may indicate an unused CG PUSCH transmission occasion in response to the bit, associated with the CG PUSCH transmission occasion, being set to one (or zero). A bit of the bitfield may indicate a used CG PUSCH transmission occasion in response to the bit, associated with the CG PUSCH transmission occasion, being set to zero (or one).

In an embodiment, a wireless device may receive, from a base station, one or more radio resource control (RRC) messages. The RRC messages include configuration parameters. The configuration parameters may indicate a configured grant (CG) with a plurality of CG physical uplink shared channel (PUSCH) transmission occasions. The wireless device may determine, based on a size of a transport block, one or more unused CG PUSCH transmission occasions from the plurality of CG PUSCH transmission occasions. The wireless device may transmit, to the base station, an uplink control information including a bitfield, with a plurality of bits, indicating the one or more unused CG PUSCH transmission occasions in response to the plurality of bits being set to non-zero. The plurality of bits of the bitfield jointly indicate the plurality of CG PUSCH transmission occasions are used in response to the plurality of bits being set to zero.

In an embodiment, a wireless device may receive, from a base station, one or more commands. The one or more commands indicate a configured grant (CG) with a plurality of CG physical uplink shared channel (PUSCH) transmission occasions. The one or more commands may indicate a time offset threshold (value). The wireless device determines one or more unused CG PUSCH transmission occasions from the plurality of CG PUSCH transmission occasions. The wireless device determines a first position for a transmission of an uplink control information (UCI). The wireless device may transmit, to the base station, via the first position, the uplink control information (UCI) indicating the one or more unused CG PUSCH transmission occasions in response to a time difference, between the first position and a starting time of the one or more unused CG PUSCH transmission occasions, being equal to or greater than the time offset threshold (value). The wireless device may transmit, to the base station, via the first position, the uplink control information (UCI) not indicating the one or more unused CG PUSCH transmission occasions in response to the time difference, between the first position and a starting time of the one or more unused CG PUSCH transmission occasions, being less than the time offset threshold (value). The first position may be an end of the last OFDM symbol of the UCI (or of the first position, e.g., the first position may be a slot). The starting time may be a beginning of the first OFDM symbol of the one or more unused CG PUSCH transmission occasions. The one or more commands include at least one of: one or more radio resource control messages; one or more medium access control control elements (MAC CEs); or one or more downlink control information (DCI).

In an embodiment, a wireless device may receive, from a base station, one or more commands. The one or more commands may indicate a configured grant (CG) with a plurality of CG physical uplink shared channel (PUSCH) transmission occasions. The one or more commands may indicate a threshold value. The wireless device may determine a CG PUSCH transmission occasion, from the plurality of PUSCH transmission occasions, as an unused CG PUSCH transmission occasion in response to an occupancy (or occupancy ratio) of the CG PUSCH transmission occasion being less than the threshold value. The wireless device may determine the CG PUSCH transmission occasion, from the plurality of CG PUSCH transmission occasions, as a used CG PUSCH transmission occasion in response to the occupancy (or occupancy ratio) of the CG PUSCH transmission occasion being equal to or greater than the threshold value. The wireless device may transmit, to the base station, an uplink control information (UCI) indicating the unused CG PUSCH transmission occasion. The one or more commands may include at least one of: one or more radio resource control messages; one or more medium access control control elements (MAC CEs); or one or more downlink control information (DCI).

In an embodiment, a wireless device may receive, from a base station, one or more commands. The one or more commands may indicate a configured grant (CG) with a plurality of CG physical uplink shared channel (PUSCH) transmission occasions. The one or more commands may indicate a threshold value. The wireless device may determine one or more unused CG PUSCH transmission occasions from the plurality of CG PUSCH transmission occasions. The wireless device may transmit, to the base station, an uplink control information (UCI) indicating the one or more unused CG PUSCH transmission occasions in response to the number of (or the ratio of) the one or more unused CG PUSCH transmission occasions being equal to or greater than the threshold value. The wireless device may transmit, to the base station, an uplink control information (UCI) not indicating the one or more unused CG PUSCH transmission occasions in response to the number of (or the ratio of) the one or more unused CG PUSCH transmission occasions being less than the threshold value. The ratio of the one or more unused CG PUSCH transmission occasions may be a ratio value between: resources of the one or more unused CG PUSCH transmission occasions, and resources of the plurality of CG PUSCH transmission occasions. The one or more commands may include at least one of: one or more radio resource control messages; one or more medium access control control elements (MAC CEs); or one or more downlink control information (DCI).

In an embodiment, a wireless device may receive, from a base station, one or more radio resource control (RRC) messages. The RRC messages include configuration parameters. The configuration parameters may indicate a configured grant (CG) with a plurality of CG physical uplink shared channel (PUSCH) transmission occasions. The wireless device may generate, at a first time, a transport block of an extended reality (XR) traffic. The wireless device may determine a first unused CG PUSCH transmission occasion and a second unused CG PUSCH transmission occasion from the plurality of CG PUSCH transmission occasions. The first unused CG PUSCH transmission occasion may be before the first time of the transport block of the extended reality (XR) traffic. The second unused CG PUSCH transmission occasion is after the first time of the transport block of the extended reality (XR) traffic. The wireless device may transmit, to the base station, an uplink control information (UCI) indicating the second unused CG PUSCH transmission occasion in response to the second unused CG PUSCH transmission occasion being after the first time of the transport block of the extended reality (XR) traffic. The wireless device may transmit, to the base station, an uplink control information (UCI) not indicating the first unused CG PUSCH transmission occasion in response to the first unused CG PUSCH transmission occasion being before the first time of the transport block of the extended reality (XR) traffic.

In an embodiment, a wireless device may receive, from a base station, one or more radio resource control (RRC) messages. The RRC messages may include configuration parameters. The configuration parameters may indicate a configured grant (CG) with a plurality of CG physical uplink shared channel (PUSCH) transmission occasions. The wireless device may determine an unused CG PUSCH transmission occasion from the plurality of CG PUSCH transmission occasions. The wireless device may determine a first used CG PUSCH transmission occasion from the plurality of CG PUSCH transmission occasions. The wireless device may determine a second used CG PUSCH transmission occasion from the plurality of CG PUSCH transmission occasions. The unused PUSCH transmission occasion may be after arrival of a first transport block of an extended reality. The first used CG PUSCH transmission occasion may be a first CG PUSCH transmission occasion after the arrival of the first transport block of the extended reality. The second used CG PUSCH transmission occasion may be used for a second transport block of the extended reality and before the arrival of the first transport block of the extended reality. The wireless device may transmit, to the base station, via the first used CG PUSCH transmission occasion, an uplink control information indicating the unused PUSCH transmission occasion in response to the first used CG PUSCH transmission occasion being after the arrival of the first transport block. The wireless device may transmit, to the base station, not via the second used CG PUSCH transmission occasion, an uplink control information indicating the unused PUSCH transmission occasion in response to the second used CG PUSCH transmission occasion being before the arrival of the first transport block.

In accordance with an embodiment, a method performed by a wireless device includes receiving, from a network controller, one or more radio resource control messages comprising configuration parameters. The radio resource control messages indicate a quantity of bitfield for uplink control information indication of unused CG PUSH transmission occasions for the CG, wherein the bitwidth of the bitfield is equal to the quantity of the one or more CG PUSCH transmission occasions and each bit of the bitfield is associated with a respective CG PUSCH transmission occasion of the one or more CG PUSCH transmission occasions. The method also includes determining a CG PUSCH transmission occasion, from the one or more CG PUSCH transmission occasions, associated with a bit from the bitfield. The method also includes determining a status of the CG PUSCH transmission occasion as an unused CG PUSCH transmission occasion in response to the bit being set to one and as a used CG PUSCH transmission occasion in response to the bit being set to zero. The method also includes transmitting a transport block via the used CG PUSCH transmission occasion.

In accordance with an embodiment, a network controller at least one processor and a non-transitory computer readable storage medium storing programming, the programming including instructions that, when executed by the at least one processor, cause the wireless device to perform any of the above disclosed methods.

In accordance with an embodiment, a wireless device, includes at least one processor; and a non-transitory computer readable storage medium storing programming, the programming including instructions that, when executed by the at least one processor, cause the wireless device to perform any of the methods described above.

In accordance with an embodiment, a non-transitory computer readable storage medium including instructions that when executed by at least one processor cause the at least one processor to perform any of the methods described above.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a diagram of an example embodiment for uplink XR traffic;

FIG. 2 illustrates a diagram of an example embodiment for parameters of uplink XR traffic;

FIG. 3 illustrates a diagram of an example embodiment for parameters of uplink XR traffic;

FIG. 4 illustrates a diagram of an example embodiment for a configured grant (CG);

FIGS. 5A and 5B illustrate a diagram of an example embodiment for periodicity configuration of CG;

FIG. 6 illustrates a diagram of an example embodiment for periodicity misalignment between XR traffic and CG;

FIG. 7 illustrates a diagram of an example embodiment for mitigation of periodicity misalignment between XR traffic and CG;

FIG. 8 illustrates a diagram of an example embodiment for mitigation of periodicity misalignment between XR traffic and CG;

FIG. 9 illustrates a diagram of an example embodiment for mitigation of confliction between CG and downlink slot;

FIG. 10 illustrates a diagram of an example embodiment for unused CG PUSCH transmission occasion(s);

FIG. 11 illustrates a diagram of an example embodiment for indications of unused CG PUSCH transmission occasion(s);

FIG. 12 illustrates a diagram of an example embodiment for indications of unused CG PUSCH transmission occasion(s);

FIG. 13 illustrates a diagram of an example embodiment for timing relationship for indications of unused CG PUSCH transmission occasion(s);

FIG. 14 illustrates a diagram of an example embodiment for indications of unused CG PUSCH transmission occasion(s);

FIG. 15 illustrates a diagram of an example embodiment for indications of unused CG PUSCH transmission occasion(s);

FIG. 16 illustrates a diagram of an example embodiment for determination of a HARQ process for CG;

FIG. 17 illustrates a diagram of an example embodiment for determination of a HARQ process for CG;

FIG. 18 illustrates a diagram of an example communications system in which embodiments described herein may be implemented;

FIG. 19 illustrates a diagram of an example communications system in which embodiments described herein may be implemented;

FIGS. 20A and 20B illustrate example devices that may implement some embodiments described herein; and

FIG. 21 illustrates a diagram of a computing system that may be used for implementing some embodiments disclosed herein.

### DETAILED DESCRIPTION OF ILLUSTRATIVE EMBODIMENTS

The following example embodiments in disclosure can be combined or split to generate one or more new embodiments. All the procedures, elements, terms, behaviors, and/or the like described in an embodiment can be applied to (or combined with) one or more other embodiments.

To support uplink XR traffic with large and variable packet size and low latency, a new work item for XR enhancement was set up in the RAN #98 plenary meeting of 3rd Generation Partnership Project (3GPP), in which configured grant (CG) without latency of scheduling request and buffer status report can be used to transmit uplink XR traffic. According to uplink XR traffic models defined in 3GPP, the size of frames for XR traffic is variable and subject to a certain probability distribution. The maximum frame size for uplink XR traffic may be multiple times of the mean packet size. To cater the large and variable frame size for uplink XR traffic, capacity enhancements for existing CG are needed as the work item mentioned. A promising approach to enhance the capacity of legacy CG is to allocate multiple CG physical uplink shared channel (PUSCH) transmission occasions in a period of a single CG PUSCH configuration as mentioned in the scope of the work item. Additionally, to further improve resources utilization efficiency of the multiple CG PUSCH transmission occasions in a period of a single CG PUSCH configuration, the unused CG PUSCH transmission occasion(s) need to be indicated by wireless device to base station and the base station may further allocate the unused CG PUSCH occasion(s) to other wireless devices (e.g., UEs). The issues of multiple CG PUSCH transmission occasions in a period of a single CG PUSCH configuration and dynamic indication of the unused CG PUSCH transmission occasion(s) are addressed, and furthermore relevant mechanisms for allocations of the multiple CG PUSCH transmission occasions and dynamic indications of the unused CG PUSCH transmission occasion(s) are provided in the disclosure.

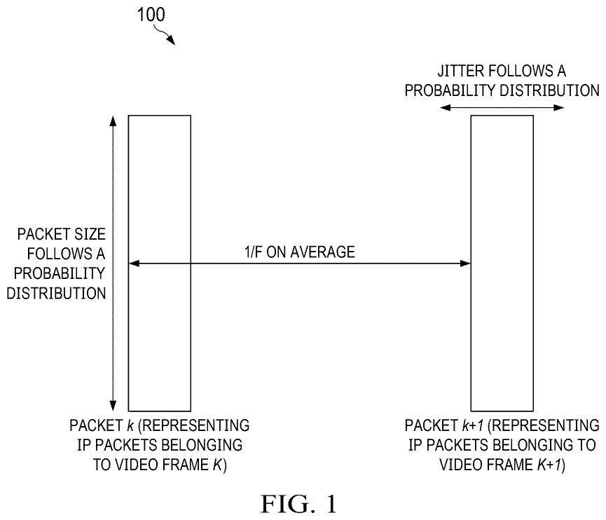

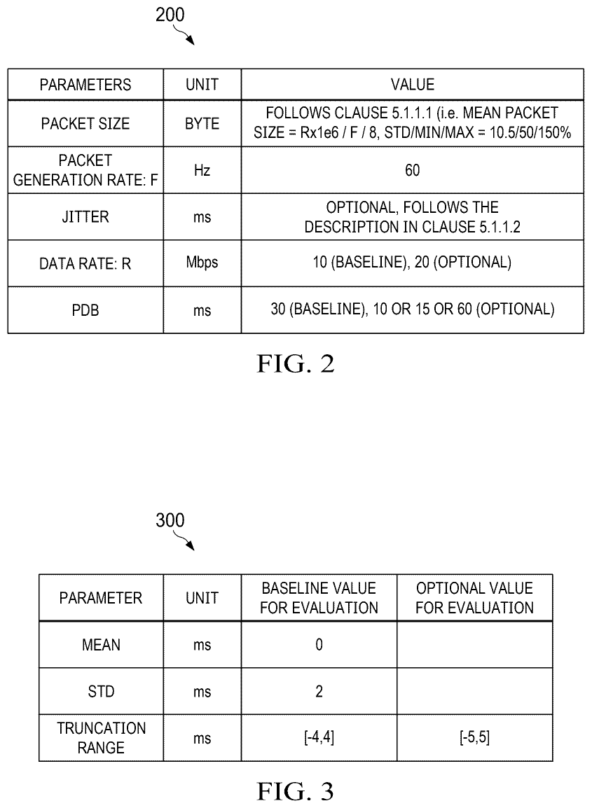

Based on the statistical parameters for uplink XR traffic model defined in 3GPP, the XR uplink traffic can be modelled as a sequence of video frames arriving at wireless device (e.g., UE) according to a considered video frame rates and random jitter. Additionally, the size of each frame is also random and subject to a certain distribution, as shown in FIG. 1. For uplink XR traffic, there are three traffic models, defined in 3GPP, including uplink VR traffic model, uplink cloud gaming traffic model, and uplink AR traffic model. In uplink AR traffic model, AR uplink flows can be modelled as a single stream with following parameters as shown in FIG. 2 and FIG. 3.

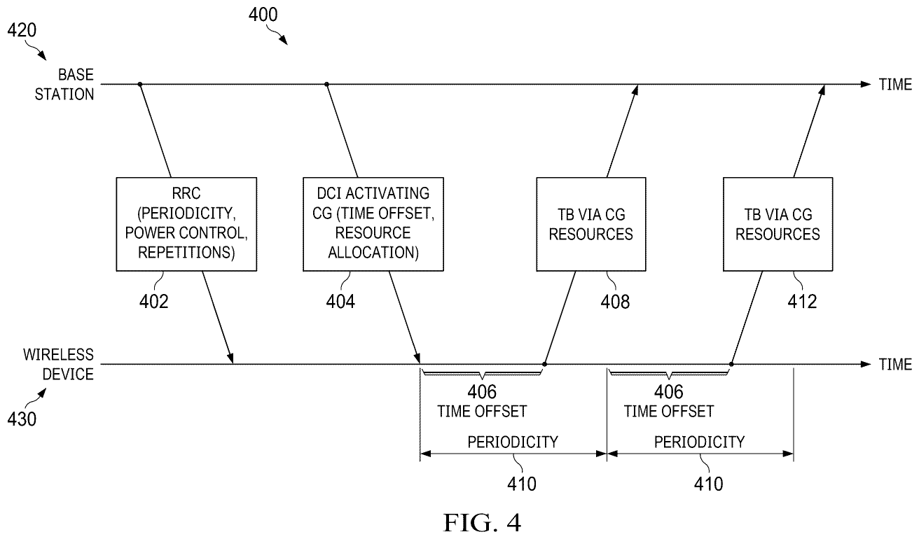

Two types of configured grant (CG) transmissions for uplink are supported in current 5G NR standard: one is type 1 CG and another one is type 2 CG. For type 1 CG, all parameters of configured grant are configured by RRC messages (e.g., received by wireless device from a base station (e.g., gNB)). However, for type 2 CG, only part of parameters of configured grant are configured by RRC messages (e.g., received by wireless device from a base station), and other parameters of configured grant are indicated by downlink control information (DCI) (e.g., received by wireless device from the base station), which not only indicates modulation and coding scheme (MCS) and available resources, but also activates the type 2 CG, as shown in FIG. 4. In Type 1 CG, RRC messages provide all CG parameters including periodicity, time offset, time-frequency allocation, UE-specific demodulation reference signal (DMRS) configuration, MCS/transport block size (TBS), #number of repetitions (K), power control, and/or the like. In Type 2 CG, RRC messages (e.g., received by wireless device from the base station) provide periodicity, power control, #number of repetitions (K), while activation DCI (e.g., received by wireless device from the base station) provides time offset, time-frequency allocation, MCS/TBS, UE-specific DMRS configuration, and/or the like. If the RRC messages include “rrc-ConfiguredUplinkGrant”, wireless device (e.g., UE) performs transmission with fully RRC-configured UL grant (i.e., Type 1 CG). If this field is absent, wireless device uses uplink (UL) grant indicated by DCI addressed to configured scheduling radio network temporary identifier (CS-RNTI) (i.e., Type 2 CG).

Regarding retransmission of transport block (TB) for CG, hybrid automatic repeat request (HARQ) process supports two schemes. One scheme is dynamic grant-based retransmission which is after the first grant free transmission via the corresponding CG resources. The other scheme is grant free transmission with multiple repetitions. If wireless device receives an explicit acknowledgement (ACK) from base station (e.g., gNB) for the transport block (TB) before transmission of any repetition of the transport block (TB), wireless device can terminate the transmission of the TB. For shared spectrum scenario, wireless device can perform autonomous uplink retransmission of the TB via CG resources if wireless device (e.g., UE) receives CG downlink feedback information (CG-DFI) indicating NACK for the TB. If it did not receive the CG-DFI (e.g., listen before talk (LBT) failure at base station) before the cg-RetransmissionTimer expires, the wireless device may perform autonomous retransmission for the TB after the cg-RetransmissionTimer expires. For both type 1 CG and type 2 CG, the HARQ identifier (ID) is implicitly determined based on the selected CG resource with a configured regular periodicity. In shared spectrum scenario, on the other hand, wireless device determines the HARQ ID for uplink autonomous transmission and indicates the determined HARQ ID to base station (e.g., gNB) via CG uplink control information (CG-UCI) piggybacked on physical uplink shared channel (PUSCH). For CG with multiple repetitions, the HARQ redundancy version (RV) for each repetition of the TB is implicitly determined based on the index of the repetition transmission occasion and an RV sequence configured by RRC messages. But for shared spectrum scenario, the wireless device determines the RV for uplink autonomous transmission/retransmission and indicates the determined RV to base station (e.g., gNB) via CG-UCI piggybacked on PUSCH.

The 3GPP standards specify the modulation formats of signals. For example, the resource elements (REs) within physical resource blocks on to which control channels and shared channels are often modulated with binary phased shift keying (BPSK), quadrature phase shift keying (QPSK)/4-QAM (quadrature amplitude modulation), 16-QAM, 64-QAM, and possibly 256-QAM. There are also references signals on the REs which may utilize a Zadoff-Chu modulation. The REs can be transformed in a waveform using an (inverse) fast Fourier transform (FFT) and/or a discrete Fourier transform (DFT) before transmission. With the introduction of a wakeup receiver, a second modulation format that is different than that described above can be used to generate a wakeup-signal. Examples of the second modulation format may include frequency shift keying (FSK) and on-off keying (OOK).

The network can provide (e.g., transmit to) a wireless device with a configuration of the wake-up signal. This configuration can include parameters, such as whether OOK or FSK is used, the bandwidth, the data rate, the symbol rate, etc. When the mobile device enables use of the WUR, the WUR is then monitoring for the WUS (first modulation format). The mobile device is no longer monitoring for the modulation formats (second modulation format) used for reference signals, control channels, shared channels. Upon detection of the WUS, the mobile device starts monitoring for the modulation formats used for reference signals, control channels, and shared channels for a configurable duration. For example, it may set a timer. Upon expiry of the time (or after the duration), the wireless device can resume monitoring for the WUS if it did not receive any control/shared channel associated with the wireless device. The association can include a RNTI.

FIG. 1 illustrates a diagram of an example embodiment for uplink XR traffic 100. The XR traffic 100 includes packet k and packet k+1. The number of frames per second of the XR traffic 100 is F. Therefore, on average the periodicity of the packets is 1/F, thus on average, packet k+1 is received 1/F after packet k is received. The packets k and k+1 each have a packet size that follows a probability distribution, such that some data packets may be larger than other data packets. Each of the packets k and k+1 could arrive early or late and this deviation from the expected arrival time is the jitter. The jitter also follows a probability distribution.

FIG. 2 illustrates a table 200 of an example embodiment for parameters of uplink XR traffic 100 shown in FIG. 1. Table 200 includes a plurality of parameters, the units for each parameter and value of the parameter. The parameters for the XR traffic packets are packet size, packet generation rate, F, jitter, data rate, R, and Packet Delay Budget (PDB). The mean packet size is R×1e6/F/8 bytes. The standard deviation of the packet size is 10.5% of the mean packet size, the minimum packet size is 50% of the mean packet size, and the maximum packet size is 150% of the mean packet size. The packet generation rate, F, is 60 Hz. Jitter is measured in ms, the data rate, R is 10 Mbps (baseline) and optionally 20 Mbps. The PDB is 30 ms (baseline) or optionally, 10 ms, 15 ms, or 60 ms.

FIG. 3 illustrates a table 300 of an example embodiment for jitter parameters of uplink XR traffic 100 shown in FIG. 1. The table 300 includes columns for parameters, units for each parameter, a baseline value for evaluation, and optional values for evaluation. The mean jitter is 0 ms baseline value and the standard deviation is 2 ms for baseline. The truncation range is from −4 ms to 4 ms before and after the mean for a baseline value and is −5 ms to 5 ms before and after the mean for an optional evaluation.

FIG. 4 illustrates a diagram of an example embodiment of a procedure 400 for a configured grant (CG). The procedure 400 provides a mechanism for configuring, activating, and transmitting based on periodicity 410 of packet generation and a time offset 406. The base station 420 transmits a radio resource control (RRC) message 402 to the wireless device 430. The RRC message 402 indicates a periodicity for packet generation, power control, and repetitions to the wireless device 430. The base station 420 then transmits a DCI activating CG 404 to the wireless device 430. The DCI activating CG 404 indicates a time offset and resource allocation to the wireless device 430. During a first periodicity 410 and after a time offset 406, the wireless device 430 transmits a transport block (TB) 408 to the base station 420 via CG resources. During a second periodicity 410 and after a time offset 406, the wireless device 430 again transmits another TB 412 to the base station 420 via the CG resources. The wireless device may continue to transmit TBs in this manner.

According to the statistical parameters for uplink XR traffic model defined in 3GPP as mentioned before, the XR uplink traffic can be modelled as a sequence of video frames arriving at the wireless device (e.g., UE) based on a considered video frame rates (e.g., F=60 frames/second) and a random jitter. More specifically, the average arrival interval or periodicity for XR uplink traffic is the inverse of the frame rate, F, and is provided by:

Periodicity of XR uplink traffic=1×10\hat{ }3 ms/F=16.67 ms, where F=60.

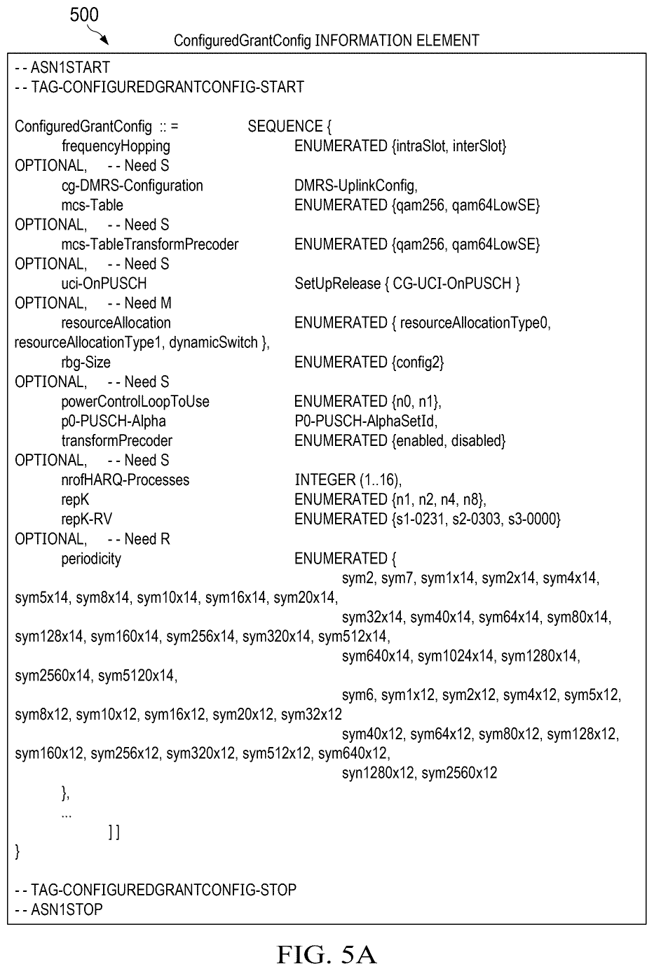

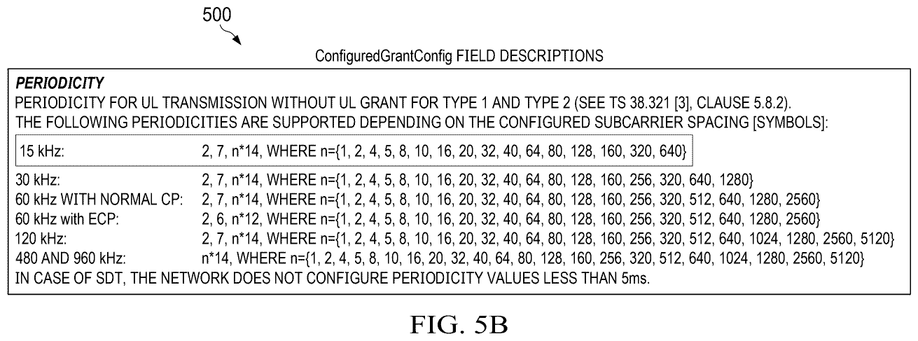

However, for CG in 5G NR, the candidate periodicities for different numerologies (e.g., different subcarrier spacing values) are configured as shown in FIGS. 5A and 5B, which illustrate a diagram 500 of an example embodiment for a periodicity configuration of the CG for a wireless device. To simplify the problem analysis, subcarrier spacing of 15 kHz is taken as an example. In this case, the periodicities (such as, for example, the periodicity 1/F in FIG. 1 or periodicity 410 in FIG. 4) can be configured as 2, 7, or n*14 orthogonal frequency division multiplexing (OFDM) symbols, where n={1, 2, 4, 5, 8, 10, 16, 20, 32, 40, 64, 80, 128, 160, 320, 640}. To match the periodicity of XR uplink traffic with a periodicity of 16.67 ms, a new periodicity of 17*14 OFDM symbols (i.e., periodicity of 17 ms) can be defined and configured to wireless device (e.g., UE) via RRC messages. However, even with the configuration with the newly defined periodicity of 17 ms, the misalignment between the periodicity of XR uplink traffic and the configured periodicity of CG still exists and becomes much larger over time due to the length difference between the periodicity of XR uplink traffic and the configured periodicity of CG.

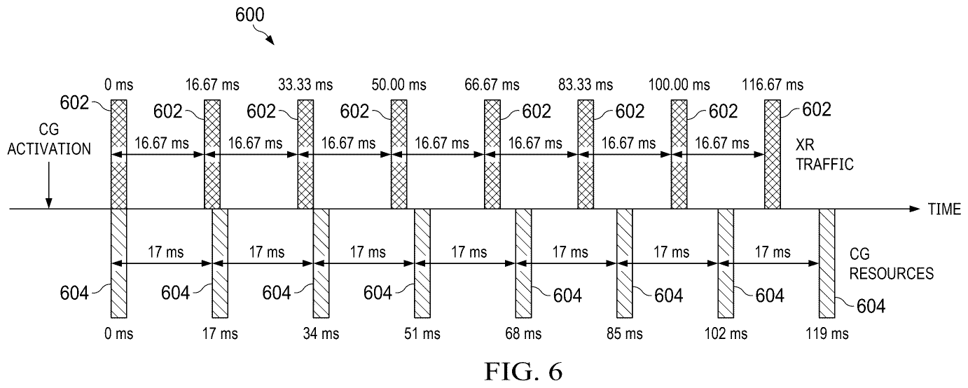

FIG. 6, shows a diagram 600 illustrating periodicity misalignment between XR traffic and the CG. Diagram 600 shows XR uplink traffic frames 602 with a periodicity of 16.67 ms on top of the time line and the CG frames 604 with a periodicity of 17 ms. Since, as discussed above, there is still misalignment between the periodicity of the XR uplink traffic and the configured periodicity of the CG, the XR transmission queuing delay keeps increasing for each subsequent XR uplink traffic frame 602 based on the newly defined and configured periodicity. Meanwhile, the transmission queuing delay caused by the misalignment takes valuable time away from the delay budget available for the scheduling and the actual transmission over the Uu link, thereby reducing scheduling flexibility and spectrum efficiency. Furthermore, this misalignment impacts packet transmission by introducing a need to buffer data for longer periods of time in order to transmit. This buffering introduces latency for traffic transmission. Thus, the large misalignment, between the periodicity of XR uplink traffic and the candidate periodicity, would significantly decrease transmission performance and quality, especially for the time critical XR traffic. Similarly, the misalignment problem also exists for other subcarrier spacing candidates and other configured periodicities. Therefore, there is a need to mitigate (or reduce) the misalignment between periodicity of XR uplink traffic and configured candidate periodicity of CG without significantly increasing signalling overhead and the power consumption for the configured grant (CG). In that sense, a mitigation (or reduction) of the misalignment between periodicity of XR uplink traffic and configured candidate periodicity of CG is proposed, and the corresponding operation procedures and signaling design for the proposed mitigation (reduction) mechanisms are also defined and disclosed.

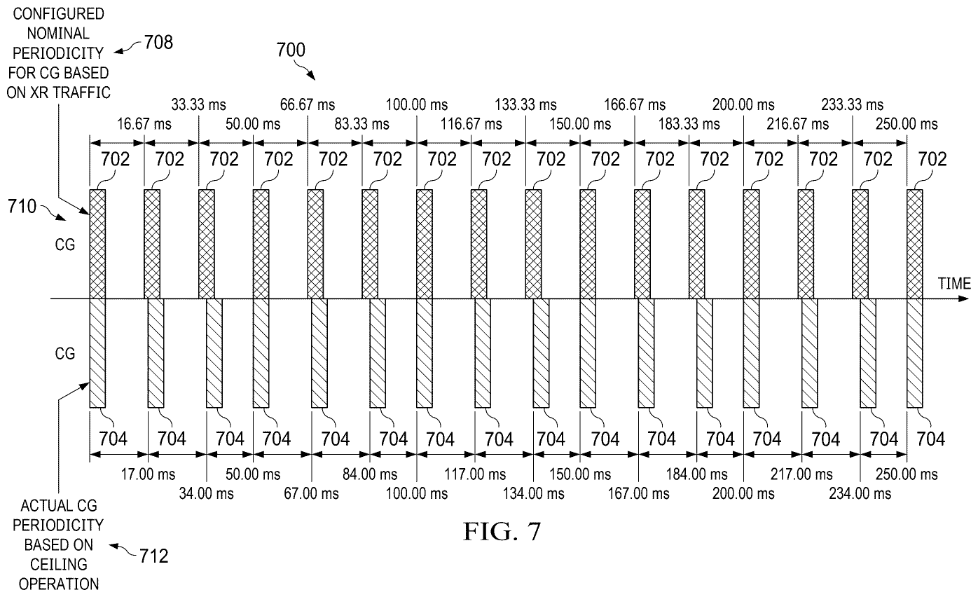

The large misalignment, between the periodicity of XR uplink traffic and candidate periodicity of CG, would significantly decrease transmission performance and quality of the time critical XR traffic. FIG. 7 illustrates a diagram of an example embodiment 700 for mitigation (or reduction) of periodicity misalignment between XR traffic and CG. The XR traffic includes a plurality of transmit frames 702 with a periodicity of 1.67 ms. The actual CG periodicity 712 between consecutive CG frames 704 varies based on the ceiling operation. In an embodiment, a wireless device (e.g., UE) may receive, from a base station (e.g., gNB), one or more radio resource control (RRC) messages. The one or more RRC messages may include configuration parameters. The configuration parameters may indicate a nominal periodicity 708 for XR traffic (or indicating the nominal periodicity for a CG). The nominal periodicity is equal to the XR traffic periodicity (e.g., 16.67 ms for F=60 frames/second frame rates). The configuration parameters may indicate a subcarrier spacing value (e.g., 15 kHz). The configuration parameters may indicate a (time) offset value for a starting time of the first periodicity duration for the XR traffic (or for the CG). The wireless device may determine, based on the nominal periodicity and/or the (time) offset value, a nominal starting time for each periodicity duration for the XR traffic (or for the CG). In an example, the wireless device may determine (or calculate) a nominal starting time of next periodicity duration as a sum of the nominal periodicity duration and a stored (or configured or initial) nominal starting time of current periodicity duration.

In an example, the stored (or configured or initial) nominal starting time of current periodicity duration may be the (time) offset value. The wireless device may update the stored nominal starting time of the current periodicity to be equal to the calculated sum, which is to be used for calculating the nominal starting time 710 of next periodicity duration for the subsequent periodicity duration. In an example, the wireless device may calculate (or determine) a nominal starting time, for each nominal periodicity duration for the XR traffic (or for the CG), as a sum of the (time) offset value and N*(nominal periodicity duration), where N is the current nominal periodicity duration index (e.g., N is 0, 1, 2, 3, . . . ). The wireless device may perform a ceiling operation upon (or on/for) the determined nominal starting time of each nominal periodicity duration for the XR traffic (or for the CG). The determined nominal starting time of each nominal periodicity duration for the XR traffic (or for the CG) is ceiled to the closest time unit (e.g., integer number of slots) with the ceiling operation. The wireless device may determine a starting time for each periodicity duration of the CG based on the ceiling operation and the determined nominal starting time of each nominal periodicity duration for the XR traffic (or for the CG). The wireless device may determine a starting time for each periodicity duration for the CG as the ceiled nominal starting time for the corresponding periodicity duration. The wireless device may use the ceiled nominal starting time as the actual starting time for the corresponding periodicity duration for CG and acts accordingly for each subsequent periodicity duration for the XR traffic (or for the CG). The wireless device may transmit, to the base station and based on the (actual) starting time, an uplink transport block via the one or more resources of the configured grant (CG). In an embodiment, the ceiling operation used for determining starting time for a periodicity duration for CG may be replaced with a floor operation. The ceiling operation may be a ceiling function. The floor operation may be a floor function.

In an embodiment, the base station (e.g., gNB) may determine, based on the nominal periodicity and/or the (time) offset value, a nominal starting time for each periodicity duration for the XR traffic (or for the CG). In an example, the base station may determine (or calculate) a nominal starting time of next periodicity duration as a sum of the nominal periodicity duration and a stored (or configured or initial) nominal starting time of current periodicity duration. In an example, the stored (or configured or initial) nominal starting time of current periodicity duration may be the (time) offset value. The base station may update the stored nominal starting time of current periodicity to be equal to the calculated sum, which is to be used for calculating the nominal starting time of next periodicity duration for the subsequent periodicity duration. In an example, the base station may calculate a nominal starting time, for each nominal periodicity duration for the XR traffic (or for the CG), as a sum of the (time) offset value and N*(nominal periodicity duration), where N is the current nominal periodicity duration index (e.g., N is 0, 1, 2, 3, . . . ). The base station may perform a ceiling operation upon (or on/for) the determined nominal starting time of each nominal periodicity duration for the XR traffic (or for the CG). The determined nominal starting time of each nominal periodicity duration for the XR traffic (or for the CG) is ceiled to the closest time unit (e.g., integer number of slots) with the ceiling operation. The base station may determine a starting time for each periodicity duration of CG based on the ceiling operation and the determined nominal starting time of each nominal periodicity duration for the XR traffic (or for the CG). The base station may determine a starting time for each periodicity duration for the CG as the ceiled nominal starting time for the corresponding periodicity duration. The base station may use the ceiled nominal starting time as the actual starting time for the corresponding periodicity duration for CG and acts accordingly for each subsequent periodicity duration for the XR traffic (or for the CG). The base station may receive, from the wireless device and based on the (actual) starting time, an uplink transport block via the one or more resources of the configured grant (CG). In an embodiment, the ceiling operation used for determining starting time for a periodicity duration for CG may be replaced with a floor operation.

In an embodiment, a wireless device may receive, from a base station, one or more radio resource control (RRC) messages. The RRC messages may include configuration parameters. The configuration parameters may indicate a subcarrier spacing value. The configuration parameters may indicate a (time) offset value. The configuration parameters may indicate a nominal periodicity for a configured grant (CG) (or for XR traffic). The nominal periodicity may be equal to a periodicity of extended reality (XR) traffic (arrival). The wireless device may determine, based on the nominal periodicity and the (time) offset value, a first starting time for one or more resources of the configured grant (CG). The wireless device may perform a ceiling operation based on the determined first starting time. The wireless device may determine, based on the ceiling operation, a second starting time for the one or more resources of the configured grant (CG). The second starting time may be a closest starting time including an integer number of slots for the subcarrier spacing value, where the closest starting time is a minimal value, with an integer number of slots, being equal to or greater than the determined first starting time corresponding to the determined second starting time. The wireless device may transmit, to the base station, based on the second starting time, an uplink transport block via the one or more resources of the configured grant (CG).

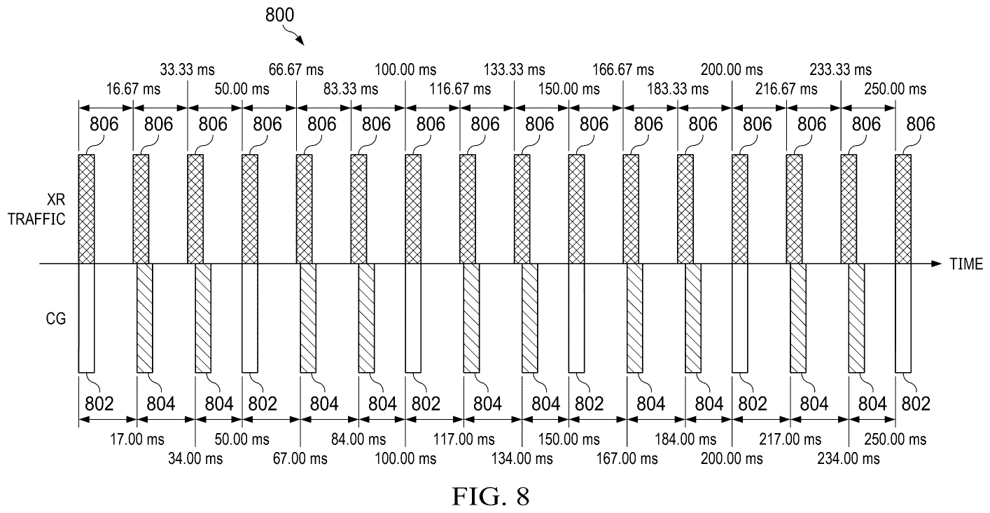

FIG. 8 illustrates a diagram of an example embodiment 800 for mitigation of periodicity misalignment between XR traffic and CG. In an embodiment, a wireless device (e.g., UE) may receive, from a base station (e.g., gNB), one or more radio resource control (RRC) messages. The one or more RRC messages include configuration parameters. The configuration parameters may indicate a combination configuration of multiple candidate periodicities. For example, the configuration parameters may indicate the configuration with format {a first periodicity, a second periodicity}. For example, the configuration parameters may indicate a first periodicity, and a second periodicity. In an example, the first periodicity may be configured with a periodicity of 50.00 ms (e.g., for F=60 frames/second) for a first set of slots 802, which is the minimum integer multiple of the periodicity, of XR uplink traffic, with an integer number of slots (e.g., for subcarrier spacing 15 kHz). Furthermore, in each periodicity duration of a single CG PUSCH configuration with the first periodicity, the wireless device may determine one or more CG PUSCH configurations (e.g., two CG PUSCH configurations are allocated with the second periodicity of 17.00 ms in each of periodicity duration with the first periodicity in this case) for a second set of slots 804, which start from the first CG PUSCH configuration (e.g., the left CG PUSCH configuration of the periodicity duration) of the periodicity duration with the first periodicity for this case. The number K of CG PUSCH configurations with the second periodicity, in a period of a single CG PUSCH configuration with the first periodicity, may be determined by the wireless device based on the below equation:

$$K = ceiling ( first periodicity / second periodicity ) - 1$$

The wireless device may determine one or more CG PUSCH configurations based on the combination configuration of multiple candidate periodicities. The wireless device may transmit, to the base station and based on the combination configuration, one or more uplink transport blocks 806 via the multiple CG PUSCH configurations.

In an embodiment, in each periodicity duration of a single CG PUSCH configuration with the first periodicity, the base station may determine one or more CG PUSCH configurations (e.g., two CG PUSCH configurations are allocated with the second periodicity of 17.00 ms in each of periodicity duration with the first periodicity in this case), which start from the first CG PUSCH configuration (e.g., the left CG PUSCH configuration of the periodicity duration) of the periodicity duration with the first periodicity for this case. The number M of CG PUSCH configurations with the second periodicity, in a period of a single CG PUSCH configuration with the first periodicity, may be determined by the base station based on the same equation as used by the wireless device. The base station may determine one or more CG PUSCH configurations based on the combination configuration of multiple candidate periodicities. The base station may receive, from the wireless device and based on the combination configuration, one or more uplink transport blocks via the multiple CG PUSCH configurations.

In an embodiment, a wireless device may receive, from a base station, one or more radio resource control (RRC) messages. The RRC messages include configuration parameters. The configuration parameters may indicate a (time) offset value for configured grant (CG). The configuration parameters may indicate a subcarrier spacing value. The configuration parameters may indicate a first periodicity for configured grant (CG). The configuration parameters may indicate a second periodicity for configured grant (CG). The first periodicity may be equal to a minimum periodicity of extended reality traffic with an integer number of slots for the subcarrier spacing value. The minimum periodicity is a minimum value selected from periodicities (e.g., with one or more XR traffic arrival intervals), of XR traffic, which can be expressed with an integer number of slots for the subcarrier spacing value. The wireless device may determine, based on the first periodicity and the (time) offset value, a first starting time for one or more resources of a configured grant. In an example, the wireless device may determine, based on the first starting time and the second periodicity, a second starting time for the one or more resources of the configured grant. The second starting time may be located within the first periodicity and occurs with the second periodicity. The wireless device may transmit, to the base station, based on the first starting time and the second starting time, one or more uplink transport blocks via one or more resources of the configured grant (CG). In an example, the base station may determine, based on the first periodicity and the (time) offset value, a first starting time for one or more resources of a configured grant. The base station may determine, based on the first starting time and the second periodicity, a second starting time for the one or more resources of the configured grant. The second starting time may be located within the first periodicity and occurs with the second periodicity. The base station may receive, from the wireless device, based on the first starting time and the second starting time, one or more uplink transport blocks via one or more resources of the configured grant (CG).

A wireless device (or a base station) may mitigate (or reduce), based the ceiling-based mechanism, the combination configuration-based mechanism, and/or the like, the misalignment between the periodicity of XR uplink traffic and candidate periodicity of CG. However, the frame structure (e.g., configured/indicated by base station) in terms of downlink resources (e.g., downlink slots) and uplink resources (e.g., uplink slots) can still impact the final CG configuration for XR uplink traffic. More specifically, if the uplink resources for a CG configuration, determined by the wireless device (or base station) and based on the ceiling-based mechanism, the combination configuration-based mechanism, and/or the like, is a downlink slot, the uplink resources of the CG configuration can't be allocated directly according to the mitigation rule. A straightforward way is just skipping the downlink slot and cancelling the allocation of the corresponding uplink resources of the CG configuration conflicted with downlink slots. Obviously, in this case, the transmission performance of the uplink XR traffic could be significantly decreased. There is a need to mitigate (or reduce) the impacts of resources confliction between a downlink resource (or slot) of a frame structure and the allocation of the CG configuration.

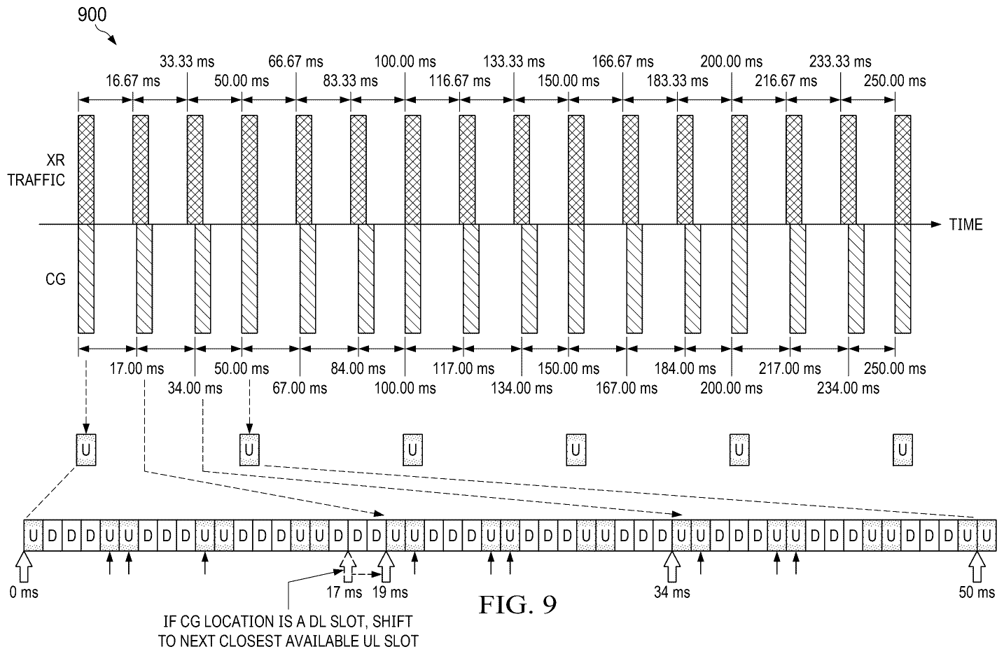

FIG. 9 illustrates a diagram of an example embodiment 900 for mitigation of confliction between CG and downlink slot. In an embodiment, a wireless device may receive, from a base station, one or more radio resource control (RRC) messages. The one or more RRC messages may include configuration parameters. The configuration parameters may indicate a frame structure including a first downlink slot and a first uplink slot. In an example, the frame structure is TDD frame structure DDDUU. The configuration parameters may indicate a configured grant (CG). The wireless device may determine, based on a resource allocation scheme, a time domain location for one or more resources of the configured grant (CG). In an example, the resource allocation scheme may be the ceiling-based mechanism, the combination configuration-based mechanism, and/or the like. The wireless device may determine that the time domain location for the one or more resources of the configured grant (CG) conflicts with the first downlink slot. In an example, the wireless device may shift (or move or adjust) (e.g., from 17 ms to 19 ms in FIG. 9) the time domain location, for the one or more resources of the configured grant, to the first uplink slot in response to the time domain location conflicting with the first downlink slot. In an example, the wireless device may shift (or move or adjust) (e.g., from 17 ms to 19 ms in FIG. 9) the time domain location, for the one or more resources of the configured grant, to the first uplink slot in response to the time domain location conflicting with a second uplink slot, configured by base station, not being available for CG PUSCH transmissions. The first uplink slot may be the closest uplink slot (e.g., for CG PUSCH transmission) to the first downlink slot. The first uplink slot may be the closest available uplink slot (e.g., for CG PUSCH transmission) to the first downlink slot. The first uplink slot may be the first available uplink slot (e.g., for CG PUSCH transmission) after the first downlink slot. The first uplink slot may be after the first downlink slot. The wireless device may transmit, to the base station and based on the first uplink slot, an uplink transport block via the one or more resources of the configured grant (CG).

In an example, the shifting (or moving or adjusting) the time domain location for the one or more resources of the configured grant (CG) is performed by the wireless device within a time window. For example, the wireless device may shift (or move or adjust) the time domain location, for the one or more resources of the configured grant, to the first uplink slot in response to the time domain location and the first uplink slot being within the time window. The wireless device may skip the time domain location, for the one or more resources of the configured grant, and/or not shift (or move or adjust) the time domain location to the first uplink slot in response to the time domain location and the first uplink slot not being within the time window. The configuration parameters may indicate the time window (or the time window is indicated by medium access control control element (MAC CE)/downlink control information (DCI) received by wireless device from the base station). In an example, the time window may be a time offset threshold between the time domain location and the first uplink slot. For example, the wireless device may shift (or move or adjust) the time domain location, for the one or more resources of the configured grant, to the first uplink slot in response to a time difference between the time domain location and the first uplink slot being equal to or less than the time offset threshold. The wireless device may skip the time domain location, for the one or more resources of the configured grant, and/or not shift (or move or adjust) the time domain location to the first uplink slot in response to the time difference between the time domain location and the first uplink slot being greater than the time offset threshold. The time difference may be from an end of the last OFDM symbol of the time domain location (e.g., a slot) to a beginning of the first OFDM symbol of the first uplink slot.

In an embodiment, the base station may determine, based on a resource allocation scheme, a time domain location for one or more resources of the configured grant (CG). In an example, the resource allocation scheme may be the ceiling-based mechanism, the combination configuration-based mechanism, and/or the like. The base station may determine that the time domain location for the one or more resources of the configured grant (CG) is conflicted with the first downlink slot. The base station may shift (or move or adjust) (e.g., from 17 ms to 19 ms in FIG. 9) the time domain location, for the one or more resources of the configured grant, to the first uplink slot in response to the time domain location being conflicted with the first downlink slot. The first uplink slot may be the closest uplink slot to the first downlink slot. In an example, the first uplink slot may be after the first downlink slot. The base station may receive, from the wireless device and based on first uplink slot, an uplink transport block via the one or more resources of the configured grant (CG).

In an example, the shifting (or moving or adjusting) the time domain location for the one or more resources of the configured grant (CG) may be performed by the base station within a time window. For example, the base station may shift (or move or adjust) the time domain location, for the one or more resources of the configured grant, to the first uplink slot in response to the time domain location and the first uplink slot being within the time window. The base station may skip the time domain location, for the one or more resources of the configured grant, and/or not shift (or move or adjust) the time domain location to the first uplink slot in response to the time domain location and the first uplink slot not being within the time window. The configuration parameters may indicate the time window (or the time window is indicated by medium access control control element (MAC CE)/downlink control information (DCI) received by wireless device from the base station). In an example, the time window may be a time offset threshold between the time domain location and the first uplink slot. For example, the base station may shift (or move or adjust) the time domain location, for the one or more resources of the configured grant, to the first uplink slot in response to a time difference between the time domain location and the first uplink slot being equal to or less than the time offset threshold. The base station may skip the time domain location, for the one or more resources of the configured grant, and/or not shift (or move or adjust) the time domain location to the first uplink slot in response to the time difference between the time domain location and the first uplink slot being greater than the time offset threshold. The time difference may be from an end of the last OFDM symbol of the time domain location (e.g., a slot) to a beginning of the first OFDM symbol of the first uplink slot.

For transmission and/or retransmission of one or more CG PUSCH transmission occasions in a period of a single CG PUSCH configuration, a transport block (TB) may be transmitted and/or retransmitted via a single CG PUSCH configuration with the one or more CG PUSCH transmission occasions, which means that a TB is transmitted and/or retransmitted via the one or more CG PUSCH transmission occasions in a period of a single CG PUSCH configuration and one or more code block groups (CBGs) of the TB is transmitted via each CG PUSCH transmission occasion of the one or more CG PUSCH transmission occasions.

Therefore, the transmission and/or retransmission of the one or more CG PUSCH transmission occasions in a period of a single CG PUSCH configuration based on a single TB is simple and efficient with much fewer HARQ processes needed, since only one HARQ process needs to be configured for the one or more CG PUSCH transmission occasions in a period of a single CG PUSCH configuration. Furthermore, wireless device (and/or base station) can determine the HARQ identifier (ID) of the HARQ process corresponding to a CG PUSCH configuration based on regular periodic resources allocated for the CG PUSCH configuration in the existing Type 1 CG and Type 2 CG. However, due to non-integer slot periodicity of XR traffic and/or CG resources allocation according to the uplink XR traffic model, the regular periodicity of the final configured CG resources for CG PUSCH configuration can't be guaranteed. Additionally, to avoid the jitter impacts on resources allocation for the CG configuration and/or to make sure wireless device has sufficient time to prepare PUSCH, a time offset may also be added between the time of XR packet arrival and starting time of CG PUSCH transmission occasion(s). Therefore, the existing HARQ ID determination mechanism based on regular periodic resource allocation of CG can't be applied directly to the one or more CG PUSCH transmission occasions in a period of a single CG PUSCH configuration for the uplink XR traffic. If wireless device decides the HARQ ID and then indicates the HARQ ID to base station, as used in NR-U in Rel-16, the uplink signaling overhead is significantly increased and at same time the power consumption for wireless device and base station is also increased. There is a need to enhance the existing HARQ process determination mechanisms to determine the HARQ process for the one or more CG PUSCH transmission occasions in a period of a single CG PUSCH configuration without a regular periodicity for one or more resources of the configured CG and without significantly increasing of singling overhead and power consumption for wireless device and base station.

In an embodiment, a wireless device may receive, from a base station, one or more radio resource control (RRC) messages. The one or more RRC messages may include configuration parameters. The configuration parameters may indicate a configured grant (CG) with one or more CG physical uplink shared channel (PUSCH) transmission occasions. The configuration parameters may indicate a (time) offset value for hybrid automatic repeat request (HARQ) identifier (ID) determination. The configuration parameters may indicate a nominal periodicity for an extended reality (XR) traffic (arrival) (or for the CG). The configuration parameters may indicate a quantity of HARQ processes for CG. The wireless device may determine, based on a current symbol, the (time) offset value, the nominal periodicity, and the quantity of HARQ processes, a HARQ identifier (ID) for the configured grant (CG). The wireless device may determine the HARQ ID using a floor operation and a modulo operation based on parameters of: the current symbol, the (time) offset value, the nominal periodicity, and the quantity of HARQ processes. In an example, the determination of the HARQ ID by the wireless device may include four steps. The four steps include a first step, a second step, a third step, and a fourth step. The first step is that the wireless device performs an operation of subtraction based on the current symbol and the (time) offset value (e.g., current symbol minus the (time) offset value). In an example, the current symbol is an index of the current OFDM symbol in time domain. The second step is that the wireless device performs an operation of division based on: a result of the operation of subtraction; and the nominal periodicity (e.g., (current symbol−the time offset)/the nominal periodicity). The third step is that wireless device performs an operation of floor based on a result of the operation of division (e.g., floor ((current symbol−the time offset)/the nominal periodicity)). The fourth step is that the wireless device performs an operation of modulo based on: a result of the operation of floor; and the quantity of HARQ processes (e.g., [floor ((current symbol−the time offset)/the nominal periodicity))] modulo (the quantity of HARQ processes). The quantity of HARQ processes may be indicated by the configuration parameters of the one or more RRC messages. The quantity of HARQ processes may be the total number of HARQ processes configured by the base station via the one or more RRC messages for CG. For example, the wireless device may determine the HARQ ID of the HARQ process for the one or more CG PUSCH transmission occasions in a period of a single CG PUSCH configuration based on the below equation:

$$HARQ Process I D = [ floor ( ( CURRENT\_symbol - time\_offset ) / ( periodicity ) ) ] modulo nrofHARQ - Processes$$

Where, the time_offset is the (time) offset value configured (or indicated) by the one or more RRC messages (or indicated by MAC CE or DCI received by the wireless device from the base station), the periodicity is the (nominal) periodicity of uplink XR traffic in terms of OFDM symbols, CURRENT_symbol is the current symbol and CURRENT_symbol=(SFN×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot refers to the number of consecutive slots per frame and the number of consecutive symbols per slot. SFN is a system frame number used for determination of the offset of a resource in time domain. nrofHARQ-Processes is the quantity of HARQ processes configured (or indicated) by the base station via the one or more RRC messages for CG. The wireless device transmits, based on the HARQ process with the HARQ ID (or based on the HARQ ID) and via the one or more CG PUSCH transmission occasions in a period of a single CG PUSCH configuration, one or more TBs to the base station. In an example, the time_offset may be configured to (or be set to) zero.

In an embodiment, the base station may determine, based on a current symbol, the (time) offset value, the nominal periodicity, and the quantity of HARQ processes, a HARQ identifier (ID) for the configured grant (CG). The base station may determine the HARQ ID using a floor operation and a modulo operation based on parameters of: the current symbol, the (time) offset value, the nominal periodicity, and the quantity of HARQ processes. In an example, the determination of the HARQ ID by the base station may include four steps. The four steps include a first step, a second step, a third step, and a fourth step. The first step is that the base station performs an operation of subtraction based on the current symbol and the (time) offset value (e.g., current symbol minus the (time) offset value). In an example, the current symbol is an index of the current OFDM symbol in time domain. The second step is that the base station performs an operation of division based on: a result of the operation of subtraction; and the nominal periodicity (e.g., (current symbol−the time offset)/the nominal periodicity). The third step is that base station performs an operation of floor based on a result of the operation of division (e.g., floor ((current symbol−the time offset)/the nominal periodicity)). The fourth step is that the base station performs an operation of modulo based on: a result of the operation of floor; and the quantity of HARQ processes (e.g., [floor ((current symbol−the time offset)/the nominal periodicity))] modulo (the quantity of HARQ processes). The quantity of HARQ processes may be indicated by the configuration parameters of the one or more RRC messages. The quantity of HARQ processes is the total number of HARQ processes configured by the base station via the one or more RRC messages for CG. For example, the base station determines the HARQ ID of the HARQ process for the one or more CG PUSCH transmission occasions in a period of a single CG PUSCH configuration based on the below equation:

$$HARQ Process I D = [ floor ( ( CURRENT\_symbol - time\_offset ) / ( periodicity ) ) ] modulo nrofHARQ - Processes$$

Where, the time_offset is the (time) offset value configured (or indicated) by the one or more RRC messages (or indicated by MAC CE or DCI received by the wireless device from the base station), the periodicity is the (nominal) periodicity of uplink XR traffic in terms of OFDM symbols, CURRENT_symbol is the current symbol and CURRENT_symbol=(SFN×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot refers to the number of consecutive slots per frame and the number of consecutive symbols per slot. SFN is a system frame number used for determination of the offset of a resource in time domain. nrofHARQ-Processes is the quantity of HARQ processes configured (or indicated) by the base station via the one or more RRC messages for CG. The base station receives, based on the HARQ process with the HARQ ID (or based on the HARQ ID) and via the one or more CG PUSCH transmission occasions in a period of a single CG PUSCH configuration, one or more TBs from the wireless device. In an example, the time_offset may be configured to (or be set to) zero.

In an embodiment, each of the one or more CG PUSCH transmission occasions in a period of a single CG PUSCH configuration may have a respective HARQ process. In an example, the wireless device may decide a respective HARQ identifier for each HARQ process of the one or more HARQ processes corresponding to the one or more CG PUSCH transmission occasions in the period of the single CG PUSCCH configuration. The wireless device may transmit the UCI, indicating the one or more decided HARQ identifiers for the one or more HARQ processes corresponding, to the one or more CG PUSCH transmission occasions to the base station. The wireless device may transmit, via the one or more CG PUSCH transmission occasions and based on the one or more HARQ processes with the one or more HARQ identifiers, one or more uplink transport blocks to the base station. In an example, the one or more CG PUSCH transmission occasions may be a plurality of CG PUSCH transmission occasions. The plurality of CG PUSCH transmission occasions may be subject to a uniform distribution within a periodicity duration (or a nominal periodicity duration) of the CG configuration. The wireless device and/or the base station may determine an HARQ identifier (ID) for each HARQ process of the plurality of CG PUSCH transmission occasions based on parameters of: the current symbol, the (time) offset value, the nominal periodicity, a quantity (e.g., M) of the plurality of CG PUSCH transmission occasions, and the quantity of HARQ processes.

In an example, the determination of the HARQ ID by the wireless device and/or the base station may include four steps. The four steps include a first step, a second step, a third step, and a fourth step. The first step is that the base station performs an operation of subtraction based on the current symbol and the (time) offset value (e.g., current symbol minus the (time) offset value). In an example, the current symbol is an index of the current OFDM symbol in time domain. The second step is that the base station performs an operation of division based on: a result of the operation of subtraction; and the nominal periodicity divided by the quantity of the plurality of CG PUSCH transmission occasions (e.g., (current symbol−the time offset)/(the nominal periodicity/M)). The third step is that base station performs an operation of floor based on a result of the operation of division (e.g., floor ((current symbol−the time offset)/(the nominal periodicity/M))). The fourth step is that the base station performs an operation of modulo based on: a result of the operation of floor; and the quantity of HARQ processes (e.g., [floor ((current symbol−the time offset)/(the nominal periodicity/M))] modulo (the quantity of HARQ processes). In an example, the wireless device and/or the base station may determine the HARQ identifier for each HARQ process of the plurality of CG PUSCH transmission occasions based on the below equation:

$$HARQ Process I D = [ floor ( ( CURRENT\_symbol - time\_offset ) / ( periodicity / M ) ) ] modulo nrofHARQ - Processes$$

Where the M is the quantity of the plurality of CG PUSCH transmission occasions in the period of the single CG PUSCCH configuration. The configuration parameters indicate (or configure) the M to the wireless device. In an example, the time_offset may be configured to (or be set to) zero. The wireless device may transmit, via a CG PUSCH transmission occasion of the plurality of CG PUSCH transmission occasion and based on a HARQ process with the determined HARQ identifier corresponding to the CG PUSCH transmission occasion, an uplink transport block to the base station. The base station may receive, via the CG PUSCH transmission occasion of the plurality of CG PUSCH transmission occasion and based on the HARQ process with the determined HARQ identifier corresponding to the CG PUSCH transmission occasion, the uplink transport block from the wireless device. The subtraction operation may be a subtraction function. The division operation may be a division function. The floor operation may be a floor function. The modulo operation may be a modulo function. The disclosed HARQ ID determination mechanisms can reduce signaling overhead transmitted in wireless network and reduce power consumptions for wireless device and base station.

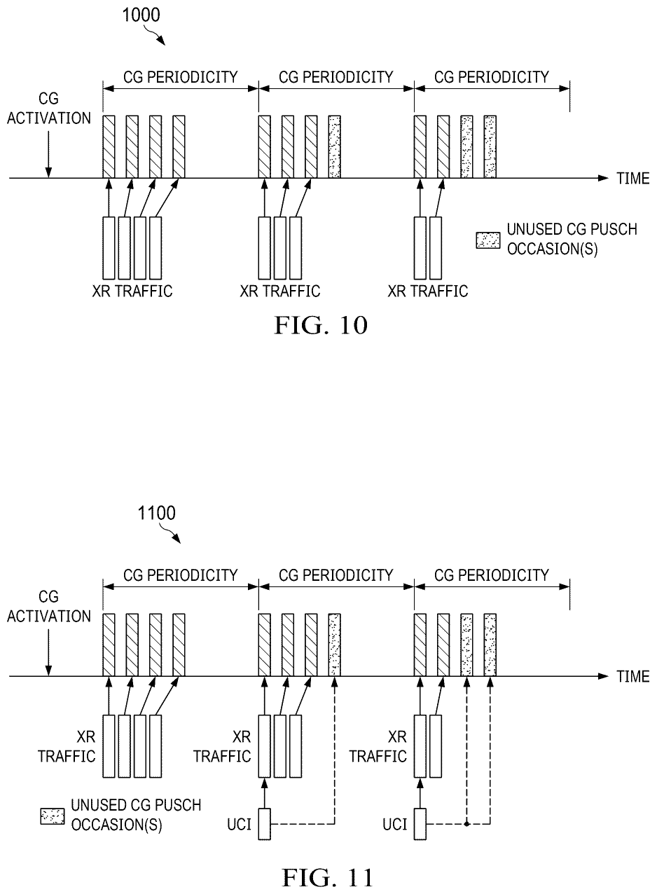

FIG. 10 illustrates a diagram of an example embodiment 1000 for unused CG PUSCH transmission occasion(s). According to uplink XR traffic model defined in 3GPP, the size of frames is variable and subject to a certain probability distribution. The maximum frame size for uplink XR traffic model can be multiple times of mean packet size. To cater the large and variable frame size for uplink XR traffic, capacity enhancements for existing CG are needed. A promising approach to enhance the capacity of CG is to configure multiple CG PUSCH transmission occasions in a period of a single CG PUSCH configuration. The multiple CG PUSCH transmission occasions in a period of a single CG PUSCH configuration may have same periodicity and different starting points. If the frame size of XR traffic results in a size of the required UL resources being equal to (or less than) the size of CG resources in a single CG PUSCH configuration, wireless device may allocate the data of the frame to all the CG PUSCH transmission occasions (or to a portion of the CG PUSCH transmission occasions). Additionally, to improve utilization efficiency of the unused CG PUSCH transmission occasion(s)/resources and allocate the unused CG PUSCH transmission occasion(s)/resources to other wireless devices (e.g., UE(s)) by base station (e.g., gNB), the unused CG PUSCH transmission occasion(s) need to be indicated to the base station (e.g., gNB) by the wireless device (e.g., UE), for example, based on uplink control information (UCI) piggybacked in PUSCH or based on an uplink MAC CE.

FIG. 11 illustrates a diagram of an example embodiment 1100 for indications of unused CG PUSCH transmission occasion(s). To reduce the waiting time for the recycling/(re) allocation of unused CG PUSCH transmission occasion(s)/resources and the blind detection complexity of base station (e.g., gNB), uplink control information (UCI) indicating the unused CG PUSCH transmission occasion(s) needs to be allocated at fixed candidate positions and transmitted by wireless device (e.g., UE) as early as possible. For example, the UCI may be transmitted to the base station by the wireless device via the first CG PUSCH transmission occasion of the multiple CG PUSCH transmission occasions (or via the first CG PUSCH transmission occasion with an actual uplink data transmission, e.g., if considering traffic jitter impacts, one or more CG PUSCH transmission occasions may have no date transmission). To increase system flexibility, base station may indicate, to the wireless device, one or more candidate positions for the UCI transmission. In an embodiment, the base station (e.g., gNB) may transmit, to the wireless device (e.g., UE), one or more RRC messages including configuration parameters (or transmit MAC CE(s)/DCI(s)) indicating the one or more candidate positions for UCI transmission by the wireless device. Based on the indications of RRC messages (or MAC CEs/DCIs), the wireless device may transmit, to the base station, the UCI indicating the unused CG PUSCH transmission occasion(s) via the one or more candidate positions. The one or more candidate positions may include the first CG PUSCH transmission occasion of the multiple CG PUSCH transmission occasions, the first CG PUSCH transmission occasion with an actual uplink data transmission, or one or more other CG PUSCH transmission occasions of the multiple CG PUSCH transmission occasions, which may (or may not) have PUSCH data transmission.

In an embodiment, a wireless device may receive, from a base station, one or more commands. The one or more commands may indicate a configured grant (CG) with a plurality of CG physical uplink shared channel (PUSCH) transmission occasions. The one or more commands may indicate one or more positions of the plurality of CG PUSCH transmission occasions. The one or more positions may include one or more CG PUSCH transmission occasions of the plurality of CG PUSCH transmission occasions. The one or more positions may include one or more frequency domain locations of the plurality of CG PUSCH transmission occasions. The wireless device may generate a transport block for an extended reality (XR) traffic. The wireless device may determine, based on a size of the transport block, one or more unused CG PUSCH transmission occasions from the plurality of CG PUSCH transmission occasions. The wireless device may transmit, to the base station, via the one or more positions, an uplink control information (UCI) indicating the one or more unused CG PUSCH transmission occasions. The one or more commands may include at least one of: one or more radio resource control (RRC) messages; one or more medium access control control elements (MAC CEs); or one or more downlink control information (DCI). The disclosed UCI position determination mechanisms can reduce power consumptions for wireless device and base station and detection complexity for base station.

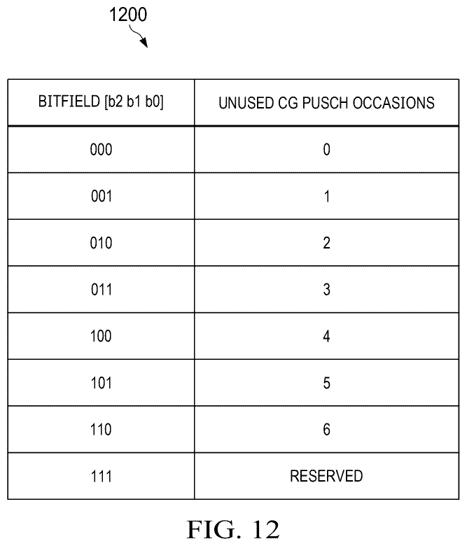

FIG. 12 illustrates a diagram of an example embodiment 1200 for indications of unused CG PUSCH transmission occasion(s). The UCI indicating unused CG PUSCH transmission occasion(s) may include a bitfield with one or more bits. In an embodiment, the bitfield has at least two bits. In an embodiment, the UCI indicating unused CG PUSCH transmission occasion(s) is based on a bitmap of the UCI. Each bit of the bitmap in the UCI is associated with one of the multiple CG PUSCH transmission occasions. For example, the quantity of the multiple CG PUSCH transmission occasions is 6. The bitwidth of the bitmap may be 6 (e.g., b5b4b3b2b1b0). If a bit of the bitmap of the UCI is set to 1 (or 0), the CG PUSCH occasion associated with the bit is unused. Instead, if the bit of the bitmap of the UCI is set to 0 (or 1), the CG PUSCH occasion associated with the bit is used. The bitwidth of the bitmap, for the UCI, indicating unused CG PUSCH occasion(s), is equal to (or less than) the quantity of the multiple CG PUSCH transmission occasions. For example, if the bitmap the UCI is set to 000111 (e.g., bitwidth of the bitmap is 6 bits, and b5b4b3b2b1b0=000111), the last three CG PUSCH transmission occasions are unused and the first three CG PUSCH transmission occasions are used. In an embodiment, the bitfield of the UCI may jointly indicate a quantity of unused CG PUSCH transmission occasions (e.g., as shown in FIG. 12). For example, the quantity of the multiple CG PUSCH transmission occasions is 6 and the bitwidth of the bitfield of the UCI is 3 bits (e.g., b2b1b0). To reduce signaling overhead in physical layer, for example, the starting point of the quantity of unused CG PUSCH transmission occasions may be starting from the end of the last CG PUSCH transmission occasion of the multiple CG PUSCH transmission occasions. In an example, the quantity of unused CG PUSCH transmission occasions may be continuous unused CG PUSCH transmission occasions, starting from the end of the last CG PUSCH transmission occasion of the multiple CG PUSCH transmission occasions, if the quantity of unused CG PUSCH transmission occasions include multiple unused CG PUSCH transmission occasions. If all the CG PUSCH transmission occasions (e.g., 6 CG PUSCH transmission occasions) are used by UE, the bitfield of UCI can be set to 000, which indicates the occupancy status for all CG PUSCH transmission occasions, of the multiple CG PUSCH occasions in UE side, to base station. In another example, if the bitfield of UCI is set to 101, unused CG PUSCH transmission occasions are 5 (i.e., the last five CG PUSCH transmission occasions of the multiple CG PUSCH transmission occasions are unused) and used CG PUSCH transmission occasion is 1 (i.e., the first CG PUSCH transmission occasion of the multiple CG PUSCH transmission occasions is used). Similarly, if the bitfield of UCI is set to 100, unused CG PUSCH transmission occasions are 4 (i.e., the last four CG PUSCH transmission occasions of the multiple CG PUSCH transmission occasions are unused) and used CG PUSCH transmission occasions are 2 (i.e., the first two CG PUSCH transmission occasions of the multiple CG PUSCH transmission occasions are used). If the unused CG PUSCH transmission occasion(s) indicted by the UCI goes into another periodicity duration, it can be ignored by the wireless device.

In an embodiment, a wireless device may receive, from a base station, one or more radio resource control (RRC) messages. The one or more RRC messages include configuration parameters. The configuration parameters may indicate a configured grant (CG) with a plurality of CG physical uplink shared channel (PUSCH) transmission occasions. The wireless device may determine, based on a size of a transport block, one or more unused CG PUSCH transmission occasions from the plurality of CG PUSCH transmission occasions. The wireless device may transmit an uplink control information (UCI) including a bitfield indicating the one or more unused CG PUSCH transmission occasions. Each bit of the bitfield may be associated with a respective CG PUSCH transmission occasion of the plurality of CG PUSCH transmission occasions. A bit of the bitfield may indicate an unused CG PUSCH transmission occasion in response to the bit, associated with the CG PUSCH transmission occasion, being set to one (or zero). A bit of the bitfield may indicate a used CG PUSCH transmission occasion in response to the bit, associated with the CG PUSCH transmission occasion, being set to zero (or one).

In an embodiment, a wireless device may receive, from a base station, one or more radio resource control (RRC) messages. The one or more RRC messages include configuration parameters. The configuration parameters may indicate a configured grant (CG) with a plurality of CG physical uplink shared channel (PUSCH) transmission occasions. The wireless device may determine, based on a size of a transport block, one or more unused CG PUSCH transmission occasions from the plurality of CG PUSCH transmission occasions. The wireless device may transmit, to the base station, an uplink control information (UCI) including a bitfield, with a plurality of bits, indicating the one or more unused CG PUSCH transmission occasions in response to the plurality of bits being set to non-zero. The plurality of bits of the bitfield may jointly indicate the plurality of CG PUSCH transmission occasions are used in response to the plurality of bits being set to zero.

The motivation for UCI indicating unused CG PUSCH transmission occasion(s) to base station (e.g., gNB) is to allocate the unused CG PUSCH transmission occasion(s) to other wireless device (e.g., UEs) to improve resource utilization efficiency. When base station (e.g., gNB) schedules an unused CG PUSCH transmission occasion to other wireless devices, base station needs to determine a time offset (e.g., K2 in 3GPP 5G NR standard) based on UE capability of PUSCH preparation time, and further indicates the time offset (e.g., K2 in 5G NR) to the other wireless devices. More specifically, the time offset (e.g., K2 in 5G NR) is a time difference between the downlink (DL) slot where the PDCCH (e.g., containing DCI) for uplink scheduling is received and the uplink (UL) slot where the UL data needs to be sent on PUSCH. Then, the other wireless devices (e.g., UEs) can perform uplink transmission via the unused CG PUSCH transmission occasion(s) to the base station (e.g., gNB) based on the time offset (e.g., K2 in 5G NR standard). To guarantee the indicated unused CG PUSCH transmission occasion(s) to be really allocated to other wireless devices (e.g., UEs), a time difference between UCI and the indicated unused CG PUSCH transmission occasion(s) should be equal to or greater than the PUSCH preparing time for at least one of the other wireless devices (e.g., UEs). Otherwise, the indicated unused CG PUSCH transmission occasion(s) can't be (re) allocated (or recycled) by base station (e.g., gNB) to any of the other wireless devices (e.g., UEs), even though UCI is detected by the base station (e.g., gNB). There is a need to enhance the indication mechanism for the unused CG PUSCH transmission occasion(s) to make sure the indicated unused CG PUSCH transmission occasion(s) to be really (re) allocated to other wireless devices (e.g., UEs).

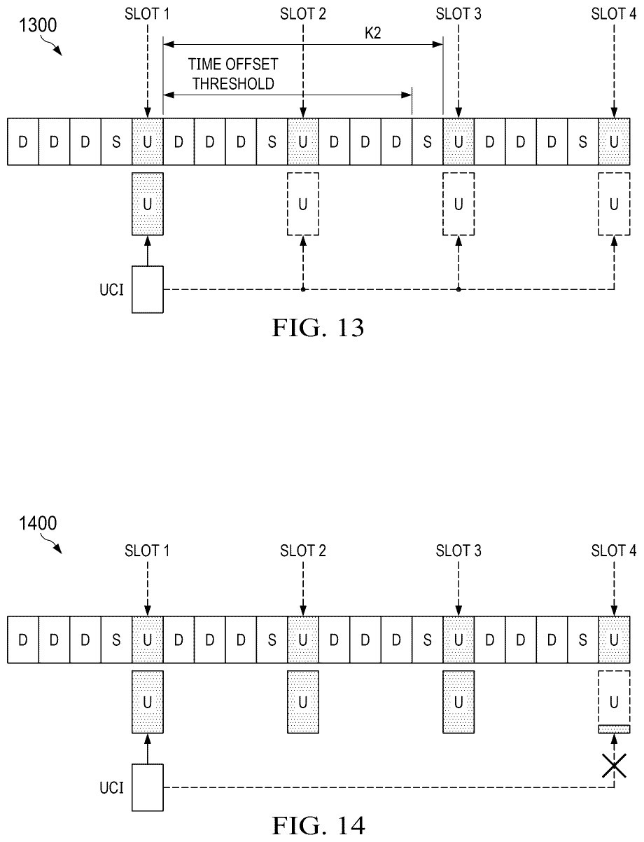

FIG. 13 illustrates a diagram of an example embodiment 1300 for timing relationship for indications of unused CG PUSCH transmission occasion(s). In an embodiment, whether unused CG PUSCH transmission occasion(s) is to be indicated by UCI transmitted by wireless device can be based on a time offset threshold indicated by based station (e.g., gNB) and a time difference between the UCI and the unused CG PUSCH transmission occasion(s). If a time difference between UCI and the unused CG PUSCH transmission occasion(s) (e.g., the time difference between an end of the last symbol of the UCI and a beginning of the first symbol of the unused CG PUSCH transmission occasion(s)) is less than the time offset threshold, the UCI may not indicate the unused CG PUSCH transmission occasion(s) to the base station. If the time difference between UCI and the unused CG PUSCH transmission occasion(s) (e.g., the time difference between an end of the last symbol of the UCI and a beginning of the first symbol of the unused CG PUSCH transmission occasion(s)) is equal to or greater than the time offset threshold, the UCI may indicate the unused CG PUSCH transmission occasion(s) to the base station. The time offset threshold is determined by the base station (e.g., gNB), for example, based on UE capability of PUSCH preparing of the other wireless devices. In an example, if there is no downlink slot (or downlink resources) between UCI and the unused CG PUSCH transmission occasion(s), the unused CG PUSCH transmission occasion(s) also can't be (re) allocated by the base station (e.g., gNB) to other UEs, therefore the UCI may not indicate the unused CG PUSCH transmission occasion(s) to the base station (e.g., gNB).

In an embodiment, a wireless device may receive, from a base station, one or more commands. The one or more commands indicate a configured grant (CG) with a plurality of CG physical uplink shared channel (PUSCH) transmission occasions. The one or more commands indicate a time offset threshold (value). The wireless device determines one or more unused CG PUSCH transmission occasions from the plurality of CG PUSCH transmission occasions. The wireless device determines a first position for transmission of an uplink control information (UCI). The wireless device may transmit, to the bases station, via the first position, the uplink control information (UCI) indicating the one or more unused CG PUSCH transmission occasions in response to a time difference, between the first position and a starting time of the one or more unused CG PUSCH transmission occasions, being equal to or greater than the time offset threshold (value). The wireless device may transmit, to the base station, via the first position, the uplink control information (UCI) not indicating the one or more unused CG PUSCH transmission occasions in response to a time difference, between the first position and a starting time of the one or more unused CG PUSCH transmission occasions, being less than the time offset threshold (value). The first position is an end of the last OFDM symbol of the UCI (or of the first position, e.g., the first position may be a slot). The starting time is a beginning of the first OFDM symbol of the one or more unused CG PUSCH transmission occasions. The one or more commands include at least one of: one or more radio resource control messages; one or more medium access control control elements (MAC CEs); or one or more downlink control information (DCI). The disclosed indication mechanisms based on a time offset threshold for unused CG PUSCH transmission occasions can reduce signaling overhead transmitted in wireless network and reduce power consumptions for wireless device and base station.

FIG. 14 illustrates a diagram of an example embodiment 1400 for indications of unused CG PUSCH transmission occasion(s). For an uplink XR traffic, the size of frames is variable and subject to a certain probability distribution. The resources of the multiple CG PUSCH transmission occasions in a period of a single CG PUSCH configuration may be designed to accommodate frame packets with sizes ranging from the minimum size to the maximum size. Due to variable frame size of XR traffic, a frame may not fully occupy all the resources of the multiple CG PUSCH transmission occasions in a period of a single CG PUSCH configuration. More specifically, the frame of the XR traffic may fully occupy slot 1, slot 2 and slot 3, but only occupies a small portion of the last CG PUSCH transmission occasion (i.e., slot 4), for instance, one or more physical resource blocks (PRBs) of the last CG PUSCH transmission occasion. If the last CG PUSCH transmission occasion is defined as a used CG PUSCH transmission occasion for this case and not indicated to base station (e.g., gNB), most resources of the last CG PUSCH transmission occasion are wasted. To further improve resources efficiency, an existing approach is to indicate the exact unused resources of the last PUSCH occasion to base station (e.g., gNB) via UCI, which significantly increases uplink signaling overhead of the UCI. Therefore, to avoid unnecessary uplink indications via UCI and reduce uplink signaling overhead, there is a need to further enhance the indications of unused CG PUSCH transmission occasion(s).

In an embodiment, a wireless device may receive, from a base station, one or more commands. The one or more commands indicate a configured grant (CG) with a plurality of CG physical uplink shared channel (PUSCH) transmission occasions. The one or more commands indicate a threshold value. The wireless device determines a CG PUSCH transmission occasion, from the plurality of CG PUSCH transmission occasions, as an unused CG PUSCH transmission occasion in response to an occupancy (or occupancy ratio) of the CG PUSCH transmission occasion being less than the threshold value. The wireless device determines the CG PUSCH transmission occasion, from the plurality of CG PUSCH transmission occasions, as a used CG PUSCH transmission occasion in response to the occupancy (or the occupancy ratio) of the CG PUSCH transmission occasion being equal to or greater than the threshold value. The occupancy of the CG PUSCH transmission occasion indicates a quantity of resources of the CG PUSCH transmission occasion are occupied by transport block(s) or data of PUSCH. The occupancy ratio of the CG PUSCH transmission occasion indicates a ratio value between: the number of the resources of the CG PUSCH transmission occasion occupied by transport block(s) (or data of PUSCH), and the total number of resources of the CG PUSCH transmission occasion. For example, the ratio value may be equal to the number of the resources of the CG PUSCH transmission occasion occupied by transport block(s) (or data of PUSCH) divided by the total number of resources of the CG PUSCH transmission occasion. The wireless device transmits, to the base station, an uplink control information (UCI) indicating the unused CG PUSCH transmission occasion. The one or more commands include at least one of: one or more radio resource control messages; one or more medium access control control elements (MAC CEs); or one or more downlink control information (DCI).

In an embodiment, a wireless device may receive, from a base station, one or more commands. The one or more commands indicate a configured grant (CG) with a plurality of CG physical uplink shared channel (PUSCH) transmission occasions. The one or more commands indicate a threshold value. The wireless device determines one or more unused CG PUSCH transmission occasions from the plurality of CG PUSCH transmission occasions. The wireless device transmits, to the base station, an uplink control information (UCI) indicating the one or more unused CG PUSCH transmission occasions in response to the number of (or the ratio of) the one or more unused CG PUSCH transmission occasions being equal to or greater than the threshold value. The wireless device transmits, to the base station, an uplink control information not indicating the one or more unused CG PUSCH transmission occasions in response to the number of (or the ratio of) the one or more unused CG PUSCH transmission occasions being less than the threshold value. The ratio of the one or more unused CG PUSCH transmission occasions is a ratio value between: resources of the one or more unused CG PUSCH transmission occasions, and resources of the plurality of CG PUSCH transmission occasions. For example, the ratio value may be equal to the number of the resources of the one or more unused CG PUSCH transmission occasions divided by the total number of resources of the plurality of CG PUSCH transmission occasions. For example, the ratio value may be equal to the number of the one or more unused CG PUSCH transmission occasions divided by the total number of the plurality of CG PUSCH transmission occasions. The one or more commands include at least one of: one or more radio resource control messages; one or more medium access control control elements (MAC CEs); or one or more downlink control information (DCI).

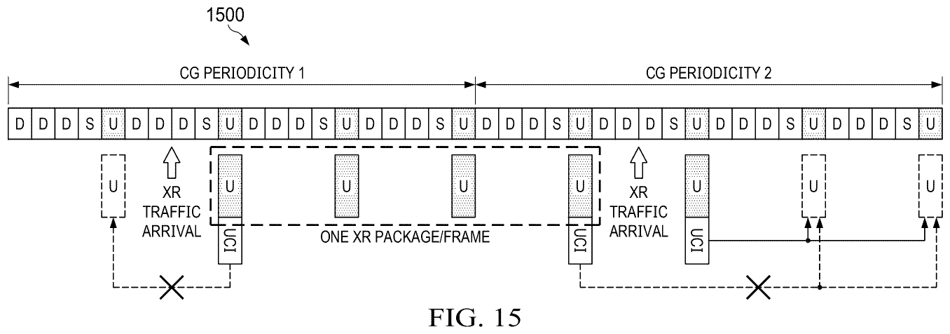

FIG. 15 illustrates a diagram of an example embodiment 1500 for indications of unused CG PUSCH transmission occasion(s). In an embodiment, a wireless device may receive, from a base station, one or more radio resource control (RRC) messages. The one or more RRC messages include configuration parameters. The configuration parameters may indicate a configured grant (CG) with a plurality of CG physical uplink shared channel (PUSCH) transmission occasions. The wireless device generates, at a first time, a transport block of an extended reality (XR). In an example, the first time may be a slot or an OFDM symbol. The wireless device may determine a first unused CG PUSCH transmission occasion and a second unused CG PUSCH transmission occasion from the plurality of CG PUSCH transmission occasions. The first unused CG PUSCH transmission occasion is before the first time of the transport block for the extended reality (XR) traffic. The second unused CG PUSCH transmission occasion is after the first time of the transport block for the extended reality (XR) traffic. The wireless device may determine, based on a size of the transport block, one or more unused CG PUSCH transmission occasions from the plurality of CG PUSCH transmission occasions. The one or more unused CG PUSCH transmission occasions include the second unused CG PUSCH transmission occasion. The wireless device may transmit, to the base station, an uplink control information (UCI) indicating the second unused CG PUSCH transmission occasion in response to the second unused CG PUSCH occasion being after the first time. The wireless device may transmit, to the base station, the uplink control information (UCI) not indicating the first unused CG PUSCH transmission occasion in response to the first unused CG PUSCH occasion being before the first time. The wireless device may transmit, to the base station, an uplink control information (UCI) indicating the one or more unused CG PUSCH transmission occasions in response to the one or more unused CG PUSCH transmission occasions being after the first time.

In an embodiment, a wireless device may receive, from a base station, one or more radio resource control (RRC) messages. The one or more RRC messages may include configuration parameters. The configuration parameters may indicate a configured grant (CG) with a plurality of CG physical uplink shared channel (PUSCH) transmission occasions. The wireless device may determine an unused CG PUSCH transmission occasion from the plurality of CG PUSCH transmission occasions. The wireless device may determine a first used CG PUSCH transmission occasion from the plurality of CG PUSCH transmission occasions. The wireless device may determine a second used CG PUSCH transmission occasion from the plurality of CG PUSCH transmission occasions. The unused CG PUSCH transmission occasion is after arrival of a first transport block of an extended reality (XR) traffic. The first used CG PUSCH transmission occasion is a first PUSCH transmission occasion after the arrival of the first transport block of the extended reality (XR) traffic. The second used CG PUSCH transmission occasion is used for a second transport block arrived at a previous periodicity of the extended reality (XR) traffic and before the arrival of the first transport block of the extended reality (XR) traffic. The wireless device may transmit, to the base station and via the first used PUSCH transmission occasion, an uplink control information (UCI) indicating the unused PUSCH transmission occasion in response to the first used PUSCH being after the arrival of the first transport block. The wireless device may transmit, to the base station and not via the second used CG PUSCH transmission occasion, an uplink control information (UCI) indicating the unused PUSCH transmission occasion in response to the second used CG PUSCH transmission occasion being before the arrival of the first transport block.

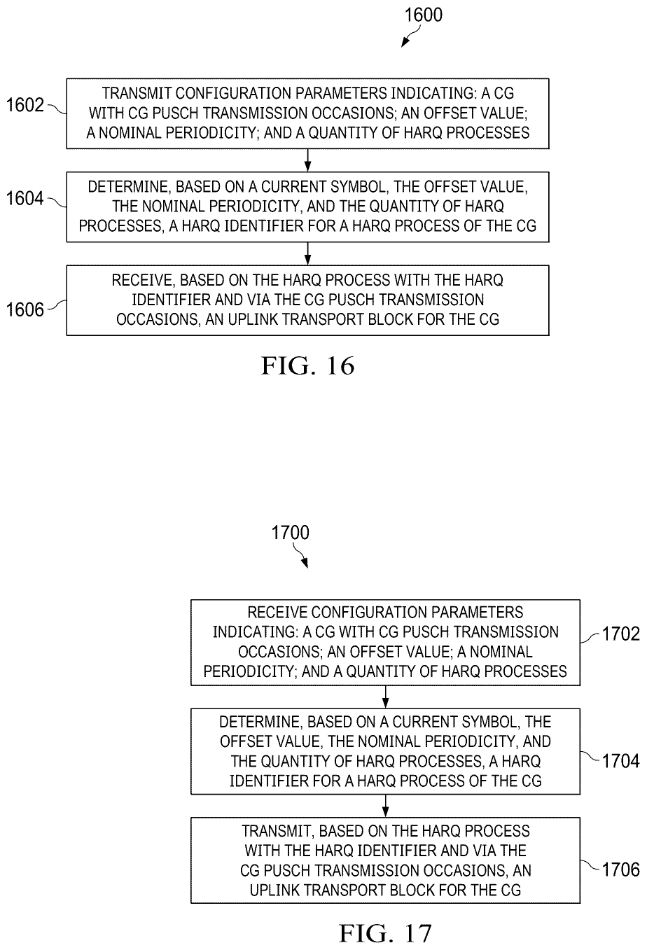

FIG. 16 illustrates a diagram of an example embodiment 1600 for determination of a HARQ process for CG. In an embodiment, a base station/network controller may transmit, to a wireless device, RRC messages including configuration parameters (step 1602). The configuration parameters may indicate a configured grant (CG) with one or more CG physical uplink shared channel (PUSCH) transmission occasions. The configuration parameters may indicate an offset value for hybrid automatic repeat request (HARQ). The configuration parameters may indicate a nominal periodicity for an extended reality traffic (or for the CG). The configuration parameters indicate a quantity of HARQ processes. The base station may determine, based on a current symbol, the offset value, the nominal periodicity, and the quantity of HARQ processes, a HARQ identifier for a HARQ process of the configured grant (CG) (step 1604). The base station/network controller may receive, based on the HARQ process with the HARQ identifier and via the one or more CG PUSCH transmission occasions, an uplink transport block for the configured grant (CG) from the wireless device (step 1606).

FIG. 17 illustrates a diagram of an example embodiment 1700 for determination of a HARQ process for CG. In an embodiment, a wireless device may receive, from a base station/network controller, RRC messages including configuration parameters (step 1702). The configuration parameters may indicate a configured grant (CG) with one or more CG physical uplink shared channel (PUSCH) transmission occasions. The configuration parameters may indicate an offset value for hybrid automatic repeat request (HARQ). The configuration parameters may indicate a nominal periodicity for an extended reality traffic (or for the CG). The configuration parameters may indicate a quantity of HARQ processes. The wireless device may determine, based on a current symbol, the offset value, the nominal periodicity, and the quantity of HARQ processes, a HARQ identifier for a HARQ process of the configured grant (CG) (step 1704). The wireless device may transmit, based on the HARQ process with the HARQ identifier and via the one or more CG PUSCH transmission occasions, an uplink transport block for the configured grant (CG) to the base station/network controller (step 1706).

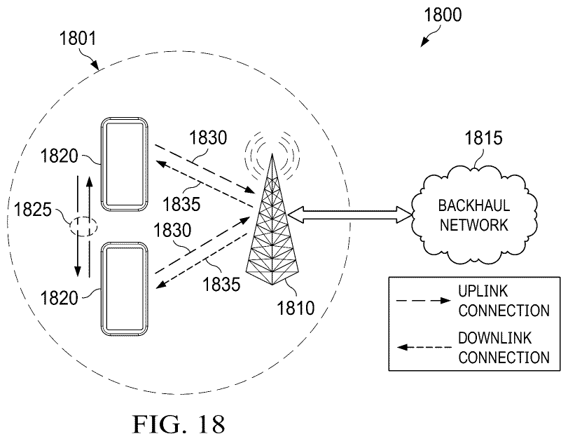

FIG. 18 illustrates an example communications system 1800 in which some embodiments may be implemented. Communications system 1800 includes an access node 1810 serving user equipment (UEs) with coverage 1801, such as UEs 1820. In a first operating mode, communications to and from a UE passes through access node 1810 with a coverage area 1801. The access node 1810 is connected to a backhaul network 1815 for connecting to the internet, operations and management, and so forth. In a second operating mode, communications to and from a UE do not pass through access node 1810, however, access node 1810 typically allocates resources used by the UE to communicate when specific conditions are met. Communications between a pair of UEs 1820 can use a sidelink connection (shown as two separate one-way connections 1825). In FIG. 18, the sideline communication is occurring between two UEs operating inside of coverage area 1801. However, sidelink communications, in general, can occur when UEs 1820 are both outside coverage area 1801, both inside coverage area 1801, or one inside and the other outside coverage area 1801. Communication between a UE and access node pair occur over uni-directional communication links, where the communication links between the UE and the access node are referred to as uplinks 1830, and the communication links between the access node and UE is referred to as downlinks 1835.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

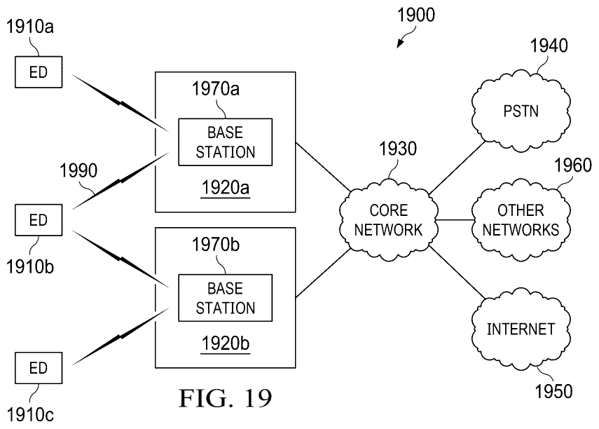

FIG. 19 illustrates an example communication system 1900 in which some embodiments discussed herein may be implemented. In general, the system 1900 enables multiple wireless or wired users to transmit and receive data and other content. The system 1900 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 1900 includes electronic devices (ED) 1910a-1910c, radio access networks (RANs) 1920a-1920b, a core network 1930, a public switched telephone network (PSTN) 1940, the Internet 1950, and other networks 1960. While certain numbers of these components or elements are shown in FIG. 19, any number of these components or elements may be included in the system 1900.

The EDs 1910a-1910c are configured to operate or communicate in the system 1900. For example, the EDs 1910a-1910c are configured to transmit or receive via wireless or wired communication channels. Each ED 1910a-1910c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 1920a-1920b here include base stations 1970a-1970b, respectively. Each base station 1970a-1970b is configured to wirelessly interface with one or more of the EDs 1910a-1910c to enable access to the core network 1930, the PSTN 1940, the Internet 1950, or the other networks 1960. For example, the base stations 1970a-1970b may include (or be) one or more of several well-known devices, such as a base transceiver station (BTS), a Node-B (NodeB), an evolved NodeB (eNB), a Next Generation (NG) NodeB (gNB), a gNB centralized unit (gNB-CU), a gNB distributed unit (gNB-DU), a Home NodeB, a Home eNodeB, a site controller, an access point (AP), or a wireless router. The EDs 1910a-1910c are configured to interface and communicate with the Internet 1950 and may access the core network 1930, the PSTN 1940, or the other networks 1960.

In the embodiment shown in FIG. 19, the base station 1970a forms part of the RAN 1920a, which may include other base stations, elements, or devices. Also, the base station 1970b forms part of the RAN 1920b, which may include other base stations, elements, or devices. Each base station 1970a-1970b operates to transmit or receive wireless signals within a particular geographic region or area, sometimes referred to as a “cell.” In some embodiments, multiple-input multiple-output (MIMO) technology may be employed having multiple transceivers for each cell.

The base stations 1970a-1970b communicate with one or more of the EDs 1910a-1910c over one or more air interfaces 1990 using wireless communication links. The air interfaces 1990 may utilize any suitable radio access technology.

It is contemplated that the system 1900 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 1920a-1920b are in communication with the core network 1930 to provide the EDs 1910a-1910c with voice, data, application, Voice over Internet Protocol (VOIP), or other services. Understandably, the RANs 1920a-1920b or the core network 1930 may be in direct or indirect communication with one or more other RANs (not shown). The core network 1930 may also serve as a gateway access for other networks (such as the PSTN 1940, the Internet 1950, and the other networks 1960). In addition, some or all of the EDs 1910a-1910c may include functionality for communicating with different wireless networks over different wireless links using different wireless technologies or protocols. Instead of wireless communication (or in addition thereto), the EDs may communicate via wired communication channels to a service provider or switch (not shown), and to the Internet 1950.

Although FIG. 19 illustrates one example of a communication system, various changes may be made to FIG. 19. For example, the communication system 1900 could include any number of EDs, base stations, networks, or other components in any suitable configuration.

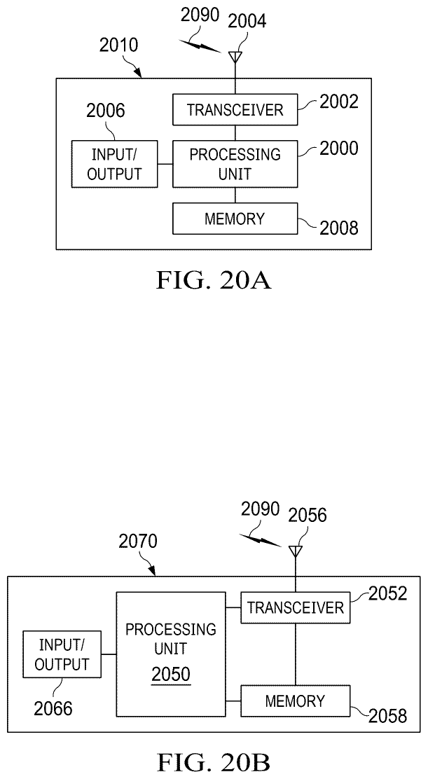

FIGS. 20A and 20B illustrate example devices that may implement some embodiments discussed herein. In particular, FIG. 20A illustrates an example ED 2010, and FIG. 20B illustrates an example base station 2070. These components could be used in the system 1900 or in any other suitable system.

As shown in FIG. 20A, the ED 2010 includes at least one processing unit 2000. The processing unit 2000 implements various processing operations of the ED 2010. For example, the processing unit 2000 could perform signal coding, data processing, power control, input/output processing, or any other functionality enabling the ED 2010 to operate in the system 1900. The processing unit 2000 also supports the methods and teachings described in more detail above. Each processing unit 2000 includes any suitable processing or computing device configured to perform one or more operations. Each processing unit 2000 could, for example, include a microprocessor, microcontroller, digital signal processor, field programmable gate array, or application specific integrated circuit.

The ED 2010 also includes at least one transceiver 2002. The transceiver 2002 is configured to modulate data or other content for transmission by at least one antenna or NIC (Network Interface Controller) 2004. The transceiver 2002 is also configured to demodulate data or other content received by the at least one antenna 2004. Each transceiver 2002 includes any suitable structure for generating signals for wireless or wired transmission or processing signals received wirelessly or by wire. Each antenna 2004 includes any suitable structure for transmitting or receiving wireless or wired signals. One or multiple transceivers 2002 could be used in the ED 2010, and one or multiple antennas 2004 could be used in the ED 2010. Although shown as a single functional unit, a transceiver 2002 could also be implemented using at least one transmitter and at least one separate receiver.

The ED 2010 further includes one or more input/output devices 2006 or interfaces (such as a wired interface to the Internet 1950). The input/output devices 2006 facilitate interaction with a user or other devices (network communications) in the network. Each input/output device 2006 includes any suitable structure for providing information to or receiving information from a user, such as a speaker, microphone, keypad, keyboard, display, or touch screen, including network interface communications.

In addition, the ED 2010 includes at least one memory 2008. The memory 2008 stores instructions and data used, generated, or collected by the ED 2010. For example, the memory 2008 could store software or firmware instructions executed by the processing unit(s) 2000 and data used to reduce or eliminate interference in incoming signals. Each memory 2008 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 20B, the base station 2070 includes at least one processing unit 2050, at least one transceiver 2052, which includes functionality for a transmitter and a receiver, one or more antennas 2056, at least one memory 2058, and one or more input/output devices or interfaces 2066. A scheduler, which would be understood by one skilled in the art, is coupled to the processing unit 2050. The scheduler could be included within or operated separately from the base station 2070. The processing unit 2050 implements various processing operations of the base station 2070, such as signal coding, data processing, power control, input/output processing, or any other functionality. The processing unit 2050 can also support the methods and teachings described in more detail above. Each processing unit 2050 includes any suitable processing or computing device configured to perform one or more operations. Each processing unit 2050 could, for example, include a microprocessor, microcontroller, digital signal processor, field programmable gate array, or application specific integrated circuit.

Each transceiver 2052 includes any suitable structure for generating signals for wireless or wired transmission to one or more EDs or other devices. Each transceiver 2052 further includes any suitable structure for processing signals received wirelessly or by wire from one or more EDs or other devices. Although shown combined as a transceiver 2052, a transmitter and a receiver could be separate components. Each antenna 2056 includes any suitable structure for transmitting or receiving wireless or wired signals. While a common antenna 2056 is shown here as being coupled to the transceiver 2052, one or more antennas 2056 could be coupled to the transceiver(s) 2052, allowing separate antennas 2056 to be coupled to the transmitter and the receiver if equipped as separate components. Each memory 2058 includes any suitable volatile or non-volatile storage and retrieval device(s). Each input/output device 2066 facilitates interaction with a user or other devices (network communications) in the network. Each input/output device 2066 includes any suitable structure for providing information to or receiving/providing information from a user, including network interface communications.

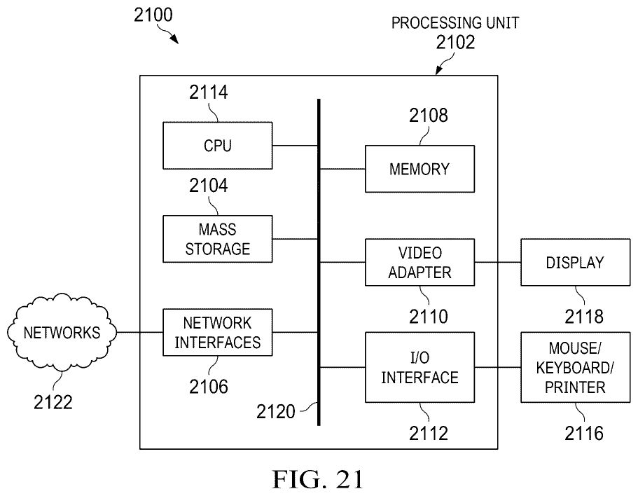

FIG. 21 is a block diagram of a computing system 2100 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 2100 includes a processing unit 2102. The processing unit includes a central processing unit (CPU) 2114, memory 2108, and may further include a mass storage device 2104, a video adapter 2110, and an I/O interface 2112 connected to a bus 2120.

The bus 2120 may be one or more of any type of several bus architectures including a memory bus or memory controller, a peripheral bus, or a video bus. The CPU 2114 may include any type of electronic data processor. The memory 2108 may include any type of non-transitory system memory such as static random access memory (SRAM), dynamic random access memory (DRAM), synchronous DRAM (SDRAM), read-only memory (ROM), or a combination thereof. In an embodiment, the memory 2108 may include ROM for use at boot-up, and DRAM for program and data storage for use while executing programs.

The mass storage 2104 may include any type of non-transitory storage device configured to store data, programs, and other information and to make the data, programs, and other information accessible via the bus 2120. The mass storage 2104 may include, for example, one or more of a solid state drive, hard disk drive, a magnetic disk drive, or an optical disk drive.

The video adapter 2110 and the I/O interface 2112 provide interfaces to couple external input and output devices to the processing unit 2102. As illustrated, examples of input and output devices include a display 2118 coupled to the video adapter 2110 and a mouse, keyboard, or printer 2116 coupled to the I/O interface 2112. Other devices may be coupled to the processing unit 2102, and additional or fewer interface cards may be utilized. For example, a serial interface such as Universal Serial Bus (USB) (not shown) may be used to provide an interface for an external device.

The processing unit 2102 also includes one or more network interfaces 2106, which may include wired links, such as an Ethernet cable, or wireless links to access nodes or different networks. The network interfaces 2106 allow the processing unit 2102 to communicate with remote units via the networks. For example, the network interfaces 2106 may provide wireless communication via one or more transmitters/transmit antennas and one or more receivers/receive antennas. In an embodiment, the processing unit 2102 is coupled to a local-area network 2122 or a wide-area network for data processing and communications with remote devices, such as other processing units, the Internet, or remote storage facilities.

In accordance with an embodiment, a method performed by a network controller includes transmitting to a wireless device one or more radio resource control messages that include configuration parameters. The configuration parameters indicate a configured grant (CG) comprising a plurality of CG physical uplink shared channel (PUSCH) transmission occasions; a periodicity for the CG; and a quantity of hybrid automatic repeat request (HARQ) processes. The method also includes determining a HARQ identifier for a HARQ process of the CG based on a current symbol, on a quantity of the plurality of PUSCH transmission occasions, on the periodicity for the CG, and on the quantity of HARQ processes. The method also includes receiving, based on the HARQ process corresponding to the HARQ identifier, and via the plurality of CG PUSCH transmission occasions, an uplink transport block for the CG from the wireless device.

In an embodiment, the determining the HARQ identifier for the HARQ process of the CG is further based on an offset value for HARQ process. In an embodiment, the determining the HARQ identifier for the HARQ process of the configured grant (CG) includes performing at least one of a subtraction operation, a division operation, a floor operation, or a modulo operation based on one or more of: the current symbol, the offset value, the nominal periodicity, or the quantity of HARQ processes. In an embodiment, the performing the subtraction operation includes performing the subtraction operation based on the current symbol and the offset value. In an embodiment, the performing the division operation includes performing the division operation based on a first result of the subtraction operation and the nominal periodicity. In an embodiment, the performing the floor operation includes performing the floor operation based on a second result of the division operation. In an embodiment, the performing the modulo operation includes performing the modulo operation based on a third result of the floor operation and the quantity of HARQ processes. In an embodiment, the offset value is a time domain offset value in terms of a quantity of orthogonal frequency-division multiplexing (OFDM) symbols. In an embodiment, the nominal periodicity is a non-integer number of slots. In an embodiment, the nominal periodicity is a nominal periodicity for the CG. In an embodiment, the quantity of HARQ processes is a total number of HARQ processes for the configured grant. In an embodiment, the current symbol is an index of a current orthogonal frequency-division multiplexing (OFDM) symbol in time domain. In an embodiment, the network controller is a first base station. In an embodiment, the nominal periodicity is for extended reality traffic. In an embodiment, the determining the HARQ identifier for the HARQ process of the configured grant (CG) includes performing a subtraction operation, a division operation, a floor operation, and a modulo operation based on one or more of: the current symbol, the offset value, the nominal periodicity, or the quantity of HARQ processes. In an embodiment, the configuration parameters further indicate the quantity of the plurality of PUSCH transmission occasions to the wireless device.

In accordance with an embodiment, a method performed by a wireless device includes receiving, from a base station, one or more radio resource control messages including configuration parameters. The configuration parameters indicate a configured grant (CG) that comprises a plurality of CG physical uplink shared channel (PUSCH) transmission occasions, a periodicity for the CG, and a quantity of hybrid automatic repeat request (HARQ) processes. The method also includes determining, based on a current symbol, a quantity of the plurality of PUSCH transmission occasions, the periodicity of the CG, the quantity of HARQ processes, and a HARQ identifier for a HARQ process of the CG. The method also includes transmitting, based on the HARQ process corresponding to the HARQ identifier, and via the plurality of CG PUSCH transmission occasions, an uplink transport block for the CG to the base station.

In an embodiment, the determining the HARQ identifier for the HARQ process of the CG is further based on an offset value for HARQ process. In an embodiment, the determining the HARQ identifier for the HARQ process of the configured grant includes performing at least one of a subtraction operation, a division operation, a floor operation, or a modulo operation based on one or more of: the current symbol, the offset value, the nominal periodicity, and the quantity of HARQ processes. In an embodiment, the performing the subtraction operation includes performing the subtraction operation based on the current symbol and the offset value. In an embodiment, the performing the division operation includes performing the division operation based on a first result of the subtraction operation and the nominal periodicity. In an embodiment, the performing the floor operation includes performing the floor operation based on a second result of the division operation. In an embodiment, the performing the modulo operation includes performing the modulo operation based on a third result of the floor operation and the quantity of HARQ processes. In an embodiment, the offset value is a time domain offset value in terms of a quantity of orthogonal frequency-division multiplexing (OFDM) symbols. In an embodiment, the nominal periodicity is a non-integer number of slots. In an embodiment, the nominal periodicity is a nominal periodicity for the CG. In an embodiment, the quantity of HARQ processes is a total number of HARQ processes for the configured grant. In an embodiment, the current symbol is an index of a current orthogonal frequency-division multiplexing (OFDM) symbol in time domain. In an embodiment, the method also includes retransmitting, based on the HARQ process with the HARQ identifier and via the one or more PUSCH transmission occasions, the uplink transport block for the configured grant (CG) to the base station. In an embodiment, the base station is a first network controller. In an embodiment, the nominal periodicity is for extended reality traffic. In an embodiment, the determining the HARQ identifier for the HARQ process of the configured grant includes performing a subtraction operation, a division operation, a floor operation, and a modulo operation based on one or more of: the current symbol, the offset value, the nominal periodicity, and the quantity of HARQ processes.

In accordance with an embodiment, a method performed by a wireless device includes receiving, from a network controller, one or more radio resource control messages that include configuration parameters. The configuration parameters indicate a bitfield for uplink control information indication of unused CG PUSH transmission occasions for the CG with one or more CG PUSCH transmission occasions. The bitwidth of the bitfield is equal to the quantity of the one or more CG PUSCH transmission occasions; and each bit of the bitfield is associated with a respective CG PUSCH transmission occasion of the one or more CG PUSCH transmission occasions. The method also includes determining a CG PUSCH transmission occasion, from the one or more CG PUSCH transmission occasions, associated with a bit from the bitfield. The method also includes determining a status of the CG PUSCH transmission occasion as an unused CG PUSCH transmission occasion in response to the bit being set to a first value and as a used CG PUSCH transmission occasion in response to the bit being set to a second value. The method also includes transmitting a transport block via the used CG PUSCH transmission occasion.

In an embodiment, the bitfield includes one or more bits. In an embodiment, the bitwidth of the bitfield is equal to the total number of bits of the bitfield. In an embodiment, the quantity of the one or more CG PUSCH transmission occasions is equal to the total number of PUSCH transmission occasions of the one or more CG PUSCH transmission occasions. In an embodiment, the association between a bit and CG PUSCH transmission occasion includes a mapping or link relationship. In an embodiment, the unused CG PUSCH transmission occasion is not used by the wireless device to transmit uplink transport blocks. In an embodiment, the used CG PUSCH transmission occasion is used by the wireless device to transmit uplink transport blocks. In an embodiment, the first value is a one and the second value is a zero. In an embodiment, the first value is a zero and the second value is a one.

In an embodiment, a wireless device may receive, from a base station, one or more radio resource control (RRC) messages. The RRC messages include configuration parameters. The configuration parameters may indicate a subcarrier spacing value. The configuration parameters may indicate a time offset value. The configuration parameters may indicate a nominal periodicity for a configured grant (CG). The nominal periodicity may be equal to a periodicity of extended reality (XR) traffic (arrival). The wireless device determines, based on the nominal periodicity and the time offset value, a first starting time for one or more resources of the configured grant (CG). The wireless device may perform a ceiling operation based on the determined first starting time, where the ceiling operation maps an input to the least integer greater than or equal to the input. The wireless device determines, based on the ceiling operation, a second starting time for the one or more resources of the configured grant (CG). The second starting time is a closest starting point including an integer number of slots for the subcarrier spacing value, where the closest starting point is a minimal value, with an integer number of slots, being equal to or greater than the determined first starting time corresponding to the determined second starting time. The wireless device transmits, to the base station, based on the second starting time, an uplink transport block via the one or more resources of the configured grant (CG). The ceiling operation may be a ceiling function.

In an embodiment, a wireless device may receive, from a base station, one or more radio resource control (RRC) messages. The RRC messages include configuration parameters. The configuration parameters may indicate a time offset value for a configured grant (CG). The configuration parameters may indicate a subcarrier spacing value. The configuration parameters may indicate a first periodicity for the configured grant (CG). The configuration parameters may indicate a second periodicity for the configured grant (CG). The first periodicity may be equal to a minimum periodicity of extended reality (XR) traffic with an integer number of slots for the subcarrier spacing value. The wireless device determines, based on the first periodicity and the time offset value, a first starting time for one or more resources of the configured grant. The wireless device may determine, based on the first starting time and the second periodicity, a second starting time for the one or more resources of the configured grant. The second starting time is located within the first periodicity and occurs with the second periodicity. The wireless device transmits, to the base station, based on the first starting time and the second starting time, one or more uplink transport blocks via the one or more resources of the configured grant.

In an embodiment, a wireless device may receive, from a base station, one or more radio resource control (RRC) messages. The RRC messages include configuration parameters. The configuration parameters may indicate a frame structure including a first downlink slot and a first uplink slot. The configuration parameters may indicate a configured grant (CG). The wireless device may determine, based on a resource allocation scheme, a time domain location for one or more resources of the configured grant. If the time domain location is conflicted with the first downlink slot, the wireless device may shift (or move or adjust) the time domain location, for the one or more resources of the configured grant, to the first uplink slot in response to the time domain location being conflicted with the first downlink slot. The first uplink slot may be the closest uplink slot to the first downlink slot. The first uplink slot may be the closest available uplink slot to the first downlink slot. The first uplink slot may be the first available uplink slot to the first downlink slot. The wireless device transmits, to the base station, based on the first uplink slot, an uplink transport block via the one or more resources of the configured grant (CG). The shifting (or moving or adjusting) the time domain location is performed by the wireless device within a time window. The time window is indicated by the configuration parameters. The resource allocation scheme includes a ceiling operation, a configuration with the first periodicity and the second periodicity, or indications of the configuration parameters. The ceiling operation may be a ceiling function.

In an embodiment, a wireless device may receive, from a base station, one or more radio resource control (RRC) messages. The RRC messages include configuration parameters. The configuration parameters may indicate a configured grant (CG) with one or more CG physical uplink shared channel (PUSCH) transmission occasions. The configuration parameters may indicate a (time) offset value for hybrid automatic repeat request (HARQ). The configuration parameters may indicate a nominal periodicity for an extended reality (XR) traffic (arrival). The configuration parameters may indicate a quantity of HARQ processes for CG. The wireless device determines, based on a current symbol, the (time) offset value, the nominal periodicity, and the quantity of HARQ processes, a HARQ identifier (ID) for the configured grant (CG). A modulo operation and a floor operation are performed by the wireless device based on the current symbol, the (time) offset value, the nominal periodicity, and the quantity of HARQ processes. The wireless device transmits, to the base station, based on the HARQ identifier (ID) and via the one or more CG PUSCH transmission occasions, an uplink transport block for the configured grant (CG). The modulo operation may be a modulo function. The floor operation may be a floor function.

In an embodiment, a wireless device may receive, from a base station, one or more radio resource control (RRC) messages. The RRC messages include configuration parameters. The configuration parameters may indicate a configured grant (CG) with one or more CG physical uplink shared channel (PUSCH) transmission occasions. The configuration parameters may indicate a (time) offset value for hybrid automatic repeat request (HARQ). The configuration parameters may indicate a nominal periodicity for an extended reality (XR) traffic (arrival). The configuration parameters may indicate a quantity of HARQ processes for CG. The base station determines, based on a current symbol, the (time) offset value, the nominal periodicity, and the quantity of HARQ processes, a HARQ identifier (ID) for the configured grant (CG). A modulo operation and a floor operation are performed by the base station based on the current symbol, the (time) offset value, the nominal periodicity, and the quantity of HARQ processes. The base station receives, from the wireless device, based on the HARQ identifier (ID) and via the one or more CG PUSCH transmission occasions, an uplink transport block for the configured grant (CG).

In an embodiment, a wireless device may receive, from a base station, one or more commands. The one or more commands may indicate a configured grant (CG) with a plurality of CG physical uplink shared channel (PUSCH) transmission occasions. The one or more commands may indicate one or more positions of the plurality of CG PUSCH transmission occasions. The one or more positions may include one or more CG PUSCH transmission occasions of the plurality of CG PUSCH transmission occasions. The one or more positions may include one or more frequency domain locations of the plurality of PUSCH transmission occasions. The wireless device may generate a transport block for an extended reality (XR) traffic. The wireless device may determine, based on a size of the transport block, one or more unused CG PUSCH transmission occasions from the plurality of CG PUSCH transmission occasions. The wireless device may transmit, to the base station, via the one or more positions, an uplink control information (UCI) indicating the one or more unused CG PUSCH transmission occasions. The one or more commands include at least one of: one or more radio resource control (RRC) messages; one or more medium access control control elements (MAC CEs); or one or more downlink control information (DCI).

In an embodiment, a wireless device may receive, from a base station, one or more radio resource control (RRC) messages. The RRC messages include configuration parameters. The configuration parameters may indicate a configured grant (CG) with a plurality of CG physical uplink shared channel (PUSCH) transmission occasions. The wireless device may determine, based on a size of a transport block, one or more unused CG PUSCH transmission occasions from the plurality of CG PUSCH transmission occasions. The wireless device may transmit an uplink control information (UCI) including a bitfield indicating the one or more unused CG PUSCH transmission occasions. Each bit of the bitfield may be associated with a respective CG PUSCH transmission occasion of the plurality of CG PUSCH transmission occasions. A bit of the bitfield may indicate an unused CG PUSCH transmission occasion in response to the bit, associated with the CG PUSCH transmission occasion, being set to one (or zero). A bit of the bitfield may indicate a used CG PUSCH transmission occasion in response to the bit, associated with the CG PUSCH transmission occasion, being set to zero (or one).

In an embodiment, a wireless device may receive, from a base station, one or more radio resource control (RRC) messages. The RRC messages include configuration parameters. The configuration parameters may indicate a configured grant (CG) with a plurality of CG physical uplink shared channel (PUSCH) transmission occasions. The wireless device may determine, based on a size of a transport block, one or more unused CG PUSCH transmission occasions from the plurality of CG PUSCH transmission occasions. The wireless device may transmit, to the base station, an uplink control information including a bitfield, with a plurality of bits, indicating the one or more unused CG PUSCH transmission occasions in response to the plurality of bits being set to non-zero. The plurality of bits of the bitfield jointly indicate the plurality of CG PUSCH transmission occasions are used in response to the plurality of bits being set to zero.

In an embodiment, a wireless device may receive, from a base station, one or more commands. The one or more commands indicate a configured grant (CG) with a plurality of CG physical uplink shared channel (PUSCH) transmission occasions. The one or more commands may indicate a time offset threshold (value). The wireless device determines one or more unused CG PUSCH transmission occasions from the plurality of CG PUSCH transmission occasions. The wireless device determines a first position for a transmission of an uplink control information (UCI). The wireless device may transmit, to the base station, via the first position, the uplink control information (UCI) indicating the one or more unused CG PUSCH transmission occasions in response to a time difference, between the first position and a starting time of the one or more unused CG PUSCH transmission occasions, being equal to or greater than the time offset threshold (value). The wireless device may transmit, to the base station, via the first position, the uplink control information (UCI) not indicating the one or more unused CG PUSCH transmission occasions in response to the time difference, between the first position and a starting time of the one or more unused CG PUSCH transmission occasions, being less than the time offset threshold (value). The first position may be an end of the last OFDM symbol of the UCI (or of the first position, e.g., the first position may be a slot). The starting time may be a beginning of the first OFDM symbol of the one or more unused CG PUSCH transmission occasions. The one or more commands include at least one of: one or more radio resource control messages; one or more medium access control control elements (MAC CEs); or one or more downlink control information (DCI).

In an embodiment, a wireless device may receive, from a base station, one or more commands. The one or more commands may indicate a configured grant (CG) with a plurality of CG physical uplink shared channel (PUSCH) transmission occasions. The one or more commands may indicate a threshold value. The wireless device may determine a CG PUSCH transmission occasion, from the plurality of PUSCH transmission occasions, as an unused CG PUSCH transmission occasion in response to an occupancy (or occupancy ratio) of the CG PUSCH transmission occasion being less than the threshold value. The wireless device may determine the CG PUSCH transmission occasion, from the plurality of CG PUSCH transmission occasions, as a used CG PUSCH transmission occasion in response to the occupancy (or occupancy ratio) of the CG PUSCH transmission occasion being equal to or greater than the threshold value. The wireless device may transmit, to the base station, an uplink control information (UCI) indicating the unused CG PUSCH transmission occasion. The one or more commands may include at least one of: one or more radio resource control messages; one or more medium access control control elements (MAC CEs); or one or more downlink control information (DCI).

In an embodiment, a wireless device may receive, from a base station, one or more commands. The one or more commands may indicate a configured grant (CG) with a plurality of CG physical uplink shared channel (PUSCH) transmission occasions. The one or more commands may indicate a threshold value. The wireless device may determine one or more unused CG PUSCH transmission occasions from the plurality of CG PUSCH transmission occasions. The wireless device may transmit, to the base station, an uplink control information (UCI) indicating the one or more unused CG PUSCH transmission occasions in response to the number of (or the ratio of) the one or more unused CG PUSCH transmission occasions being equal to or greater than the threshold value. The wireless device may transmit, to the base station, an uplink control information (UCI) not indicating the one or more unused CG PUSCH transmission occasions in response to the number of (or the ratio of) the one or more unused CG PUSCH transmission occasions being less than the threshold value. The ratio of the one or more unused CG PUSCH transmission occasions may be a ratio value between: resources of the one or more unused CG PUSCH transmission occasions, and resources of the plurality of CG PUSCH transmission occasions. The one or more commands may include at least one of: one or more radio resource control messages; one or more medium access control control elements (MAC CEs); or one or more downlink control information (DCI).

In an embodiment, a wireless device may receive, from a base station, one or more radio resource control (RRC) messages. The RRC messages include configuration parameters. The configuration parameters may indicate a configured grant (CG) with a plurality of CG physical uplink shared channel (PUSCH) transmission occasions. The wireless device may generate, at a first time, a transport block of an extended reality (XR) traffic. The wireless device may determine a first unused CG PUSCH transmission occasion and a second unused CG PUSCH transmission occasion from the plurality of CG PUSCH transmission occasions. The first unused CG PUSCH transmission occasion may be before the first time of the transport block of the extended reality (XR) traffic. The second unused CG PUSCH transmission occasion is after the first time of the transport block of the extended reality (XR) traffic. The wireless device may transmit, to the base station, an uplink control information (UCI) indicating the second unused CG PUSCH transmission occasion in response to the second unused CG PUSCH transmission occasion being after the first time of the transport block of the extended reality (XR) traffic. The wireless device may transmit, to the base station, an uplink control information (UCI) not indicating the first unused CG PUSCH transmission occasion in response to the first unused CG PUSCH transmission occasion being before the first time of the transport block of the extended reality (XR) traffic.

In an embodiment, a wireless device may receive, from a base station, one or more radio resource control (RRC) messages. The RRC messages may include configuration parameters. The configuration parameters may indicate a configured grant (CG) with a plurality of CG physical uplink shared channel (PUSCH) transmission occasions. The wireless device may determine an unused CG PUSCH transmission occasion from the plurality of CG PUSCH transmission occasions. The wireless device may determine a first used CG PUSCH transmission occasion from the plurality of CG PUSCH transmission occasions. The wireless device may determine a second used CG PUSCH transmission occasion from the plurality of CG PUSCH transmission occasions. The unused PUSCH transmission occasion may be after arrival of a first transport block of an extended reality. The first used CG PUSCH transmission occasion may be a first CG PUSCH transmission occasion after the arrival of the first transport block of the extended reality. The second used CG PUSCH transmission occasion may be used for a second transport block of the extended reality and before the arrival of the first transport block of the extended reality. The wireless device may transmit, to the base station, via the first used CG PUSCH transmission occasion, an uplink control information indicating the unused PUSCH transmission occasion in response to the first used CG PUSCH transmission occasion being after the arrival of the first transport block. The wireless device may transmit, to the base station, not via the second used CG PUSCH transmission occasion, an uplink control information indicating the unused PUSCH transmission occasion in response to the second used CG PUSCH transmission occasion being before the arrival of the first transport block.

In accordance with an embodiment, a method performed by a wireless device includes receiving, from a network controller, one or more radio resource control messages comprising configuration parameters. The radio resource control messages indicate a quantity of bitfield for uplink control information indication of unused CG PUSH transmission occasions for the CG, wherein the bitwidth of the bitfield is equal to the quantity of the one or more CG PUSCH transmission occasions and each bit of the bitfield is associated with a respective CG PUSCH transmission occasion of the one or more CG PUSCH transmission occasions. The method also includes determining a CG PUSCH transmission occasion, from the one or more CG PUSCH transmission occasions, associated with a bit from the bitfield. The method also includes determining a status of the CG PUSCH transmission occasion as an unused CG PUSCH transmission occasion in response to the bit being set to one and as a used CG PUSCH transmission occasion in response to the bit being set to zero. The method also includes transmitting a transport block via the used CG PUSCH transmission occasion.

In accordance with an embodiment, a method performed by a wireless device includes receiving, from a network controller, one or more radio resource control messages comprising configuration parameter. The configuration parameters indicate a bitfield for uplink control information indication of an unused configured grant (CG) physical uplink shared channel (PUSCH) transmission occasions for a CG with one or more CG PUSCH transmission occasions, wherein: the bitwidth of the bitfield is equal to the quantity of the one or more CG PUSCH transmission occasions; and each bit of the bitfield is associated with a respective CG PUSCH transmission occasion of the one or more CG PUSCH transmission occasions. The method also includes determining a CG PUSCH transmission occasion, from the one or more CG PUSCH transmission occasions, associated with a bit from the bitfield. The method also includes determining a status of the CG PUSCH transmission occasion as: an unused CG PUSCH transmission occasion in response to the bit being set to a first value; and a used CG PUSCH transmission occasion in response to the bit being set to a second value. The method also includes transmitting a transport block via the used CG PUSCH transmission occasion.

In an embodiment, the bitfield includes two or more bits. In an embodiment, the bitwidth of the bitfield is equal to the total number of bits of the bitfield. In an embodiment, the quantity of the one or more CG PUSCH transmission occasions is equal to the total number of PUSCH transmission occasions of the one or more CG PUSCH transmission occasions. In an embodiment, the association between a bit and CG PUSCH transmission occasion comprises a mapping or link relationship. In an embodiment, the unused CG PUSCH transmission occasion is not used by the wireless device to transmit uplink transport blocks. In an embodiment, the used CG PUSCH transmission occasion is used by the wireless device to transmit uplink transport blocks. In an embodiment, the first value is a one and the second value is a zero. In an embodiment, the first value is a zero and the second value is a one. In an embodiment, the method also includes transmitting the bitfield to the network controller, wherein the bitfield indicates an unused CG PUSCH transmission occasion.

In accordance with an embodiment, a method performed by a base station includes transmitting one or more radio resource control (RRC) messages to a wireless device, wherein the one or more (RRC) messages comprise configuration parameters. The configuration parameters indicate a bitfield for uplink control information indication of an unused configured grant (CG) physical uplink shared channel (PUSCH) transmission occasions for a CG with one or more CG PUSCH transmission occasions, wherein: the bitwidth of the bitfield is equal to the quantity of the one or more CG PUSCH transmission occasions; and each bit of the bitfield is associated with a respective CG PUSCH transmission occasion of the one or more CG PUSCH transmission occasions. The method also includes receiving a transport block via one of the CG PUSCH transmission occasions.

In an embodiment, the bitfield includes two or more bits. In an embodiment, the bitwidth of the bitfield is equal to the total number of bits of the bitfield. In an embodiment, the quantity of the one or more CG PUSCH transmission occasions is equal to the total number of PUSCH transmission occasions of the one or more CG PUSCH transmission occasions. In an embodiment, the association between a bit and a CG PUSCH transmission occasion comprises a mapping or link relationship. In an embodiment, the unused CG PUSCH transmission occasion is not used by the wireless device to transmit uplink transport blocks. In an embodiment, the used CG PUSCH transmission occasion is used by the base station to receive uplink transport blocks from the wireless device. In an embodiment, the first value is a one and the second value is a zero. In an embodiment, the first value is a zero and the second value is a one. In an embodiment, the method also includes receiving a bitfield from the wireless device, wherein the bitfield indicates an unused CG PUSCH transmission occasion. In an embodiment, the method also includes scheduling another device to use the unused CG PUSCH transmission occasion.

In accordance with an embodiment, a method performed by a wireless device includes receiving, from a base station, one or more radio resource control messages comprising configuration parameters. The configuration parameters indicate a configured grant (CG) that comprises a plurality of CG physical uplink shared channel (PUSCH) transmission occasions; a periodicity for the CG; and a quantity of hybrid automatic repeat request (HARQ) processes. The method also includes determining, based on a current symbol, a quantity of the plurality of PUSCH transmission occasions, the periodicity of the CG, and the quantity of HARQ processes, a HARQ identifier for a HARQ process of the CG. The method also includes transmitting, based on the HARQ identifier, and via the plurality of CG PUSCH transmission occasions, an uplink transport block for the CG to the base station.

In an embodiment, the determining the HARQ identifier for the HARQ process of the CG is further based on an offset value for HARQ process. In an embodiment, the determining the HARQ identifier for the HARQ process of the configured grant comprises performing at least one of a division operation, a floor operation, or a modulo operation based on one or more of: the current symbol, the offset value, the nominal periodicity, and the quantity of HARQ processes. In an embodiment, the performing the division operation further comprises performing a subtraction operation and wherein the subtraction operation comprises performing the subtraction operation based on the current symbol and the offset value. In an embodiment, the performing the division operation comprises performing the division operation based on the nominal periodicity. In an embodiment, the performing the division operation further comprises performing the division operation based on a first result of a subtraction operation. In an embodiment, the performing the floor operation comprises performing the floor operation based on a second result of the division operation. In an embodiment, the performing the modulo operation comprises performing the modulo operation based on a third result of the floor operation and the quantity of HARQ processes. In an embodiment, the offset value is a time domain offset value in terms of a quantity of orthogonal frequency-division multiplexing (OFDM) symbols. In an embodiment, the nominal periodicity is a non-integer number of slots. In an embodiment, the nominal periodicity is a nominal periodicity for the CG. In an embodiment, the quantity of HARQ processes is a total number of HARQ processes for the configured grant. In an embodiment, the current symbol is an index of a current orthogonal frequency-division multiplexing (OFDM) symbol in time domain. In an embodiment, wherein the method also includes retransmitting, based on the HARQ process with the HARQ identifier and via the one or more PUSCH transmission occasions, the uplink transport block for the configured grant (CG) to the base station. In an embodiment, the base station is a first network controller. In an embodiment, the nominal periodicity is for extended reality traffic. In an embodiment, the determining the HARQ identifier for the HARQ process of the configured grant comprises performing a subtraction operation, a division operation, a floor operation, and a modulo operation based on one or more of: the current symbol, the offset value, the nominal periodicity, and the quantity of HARQ processes.

In accordance with an embodiment, a method performed by a network controller includes transmitting to a wireless device one or more radio resource control messages comprising configuration parameters. The configuration parameters include a configured grant (CG) comprising a plurality of CG physical uplink shared channel (PUSCH) transmission occasions; a periodicity for the CG; and a quantity of hybrid automatic repeat request (HARQ) processes. The method also includes determining a HARQ identifier for a HARQ process of the CG based on a current symbol, on a quantity of the plurality of PUSCH transmission occasions, on the periodicity for the CG, and on the quantity of HARQ processes. The method also includes receiving, based on the HARQ identifier, and via the plurality of CG PUSCH transmission occasions, an uplink transport block for the CG from the wireless device.

In an embodiment, the determining the HARQ identifier for the HARQ process of the CG is further based on an offset value for HARQ process. In an embodiment, the determining the HARQ identifier for the HARQ process of the configured grant (CG) comprises performing at least one of a division operation, a floor operation, or a modulo operation based on one or more of: the current symbol, the offset value, the nominal periodicity, or the quantity of HARQ processes. In an embodiment, the performing the subtraction operation comprises performing the subtraction operation based on the current symbol and the offset value. In an embodiment, the performing the division operation comprises performing the division operation based on the nominal periodicity. In an embodiment, the performing the division operation further comprises performing the division operation based on a first result of a subtraction operation. In an embodiment, the performing the floor operation comprises performing the floor operation based on a second result of the division operation. In an embodiment, the performing the modulo operation comprises performing the modulo operation based on a third result of the floor operation and the quantity of HARQ processes. In an embodiment, the offset value is a time domain offset value in terms of a quantity of orthogonal frequency-division multiplexing (OFDM) symbols. In an embodiment, the nominal periodicity is a non-integer number of slots. In an embodiment, the nominal periodicity is a nominal periodicity for the CG. In an embodiment, the quantity of HARQ processes is a total number of HARQ processes for the configured grant. In an embodiment, the current symbol is an index of a current orthogonal frequency-division multiplexing (OFDM) symbol in time domain. In an embodiment, the network controller is a first base station. In an embodiment, the nominal periodicity is for extended reality traffic. In an embodiment, the determining the HARQ identifier for the HARQ process of the configured grant (CG) comprises performing a division operation, a floor operation, and a modulo operation based on one or more of: the current symbol, the offset value, the nominal periodicity, or the quantity of HARQ processes. In an embodiment, the configuration parameters further indicate the quantity of the plurality of PUSCH transmission occasions to the wireless device.

In accordance with an embodiment, a network controller at least one processor and a non-transitory computer readable storage medium storing programming, the programming including instructions that, when executed by the at least one processor, cause the wireless device to perform any of the above disclosed methods.

In accordance with an embodiment, a wireless device, includes at least one processor; and a non-transitory computer readable storage medium storing programming, the programming including instructions that, when executed by the at least one processor, cause the wireless device to perform any of the methods described above.

In accordance with an embodiment, a non-transitory computer readable storage medium including instructions that when executed by at least one processor cause the at least one processor to perform any of the methods described above.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the present disclosure and its advantages have been described in detail, it should be understood that various changes, substitutions and alterations can be made herein without departing from the scope of this disclosure.

1. A method performed by a wireless device, the method comprising:
receiving, from a network controller, one or more radio resource control (RRC) messages comprising configuration parameters indicating a bitfield for uplink control information indication of configured grant (CG) physical uplink shared channel (PUSCH) transmission occasions for a CG with one or more CG PUSCH transmission occasions, wherein:
a bitwidth of the bitfield is equal to a quantity of the one or more CG PUSCH transmission occasions; and
each bit of the bitfield is associated with a respective CG PUSCH transmission occasion of the one or more CG PUSCH transmission occasions;
determining bit values for the bitfield;
transmitting the bitfield; and
transmitting, via at least one used CG PUSCH transmission occasion from the one or more CG PUSCH transmission occasions, a transport block, wherein a status of each of the one or more CG PUSCH transmission occasions is:
an unused CG PUSCH transmission occasion for an associated bit set to a first value; or
a used CG PUSCH transmission occasion for the associated bit set to a second value.

2. The method of claim 1, wherein the bitfield comprises two or more bits.

3. The method of claim 1, wherein the bitwidth of the bitfield is equal to a total number of bits of the bitfield.

4. The method of claim 1, wherein the quantity of the one or more CG PUSCH transmission occasions is equal to a total number of PUSCH transmission occasions of the one or more CG PUSCH transmission occasions.

5. The method of claim 1, wherein an association between the associated bit and the respective CG PUSCH transmission occasion comprises a mapping or link relationship.

6. The method of claim 1, wherein the unused CG PUSCH transmission occasion is not used by the wireless device to transmit uplink transport blocks.

7. The method of claim 1, wherein the used CG PUSCH transmission occasion is used by the wireless device to transmit uplink transport blocks.

8. The method of claim 1, wherein the first value is a one and the second value is zero.

9. The method of claim 1, wherein the first value is a zero and the second value is a one.

10. The method of claim 1, further comprising:
transmitting the bitfield to the network controller, wherein the bitfield indicates the unused CG PUSCH transmission occasion.

11. A method performed by a wireless device, the method comprising:
receiving, from a base station, one or more radio resource control (RRC) messages comprising configuration parameters indicating:
a configured grant (CG) that comprises a plurality of CG physical uplink shared channel (PUSCH) transmission occasions;
a periodicity for the CG; and
a quantity of hybrid automatic repeat request (HARQ) processes;
determining, based on a current symbol, a quantity of the plurality of CG PUSCH transmission occasions, the periodicity of the CG, and the quantity of HARQ processes, a HARQ identifier for a HARQ process of the CG; and
transmitting, based on the HARQ identifier, and via the plurality of CG PUSCH transmission occasions, an uplink transport block for the CG to the base station.

12. The method of claim 11, wherein the determining the HARQ identifier for the HARQ process of the CG is further based on an offset value for the HARQ process.

13. The method of claim 12, wherein the determining the HARQ identifier for the HARQ process of the CG comprises performing at least one of a division operation, a floor operation, or a modulo operation based on one or more of: the current symbol, the offset value, a nominal periodicity, or the quantity of HARQ processes.

14. The method of claim 13, wherein the performing the division operation further comprises performing a subtraction operation and wherein the subtraction operation comprises performing the subtraction operation based on the current symbol and the offset value.

15. The method of claim 13, wherein the performing the division operation comprises performing the division operation based on the nominal periodicity.

16. The method of claim 15, wherein the performing the division operation further comprises performing the division operation based on a first result of a subtraction operation.

17. The method of claim 13, wherein the performing the floor operation comprises performing the floor operation based on a second result of the division operation.

18. The method of claim 13, wherein the performing the modulo operation comprises performing the modulo operation based on a third result of the floor operation and the quantity of HARQ processes.

19. The method of claim 12, wherein the offset value is a time domain offset value in terms of a quantity of orthogonal frequency-division multiplexing (OFDM) symbols.

20. The method of claim 11, wherein the quantity of HARQ processes is a total number of HARQ processes for the CG.

21. The method of claim 11, wherein the current symbol is an index of a current orthogonal frequency-division multiplexing (OFDM) symbol in time domain.

22. The method of claim 11, further comprising retransmitting, based on the HARQ process with the HARQ identifier and via the plurality of CG PUSCH transmission occasions, the uplink transport block for the CG to the base station.
